(19) United States
(12) Patent Application Publication
(10) Pub. No.: US 2023/0063311 A1
(43) Pub. Date: Mar. 2, 2023

(54) INFORMATION PROCESSING APPARATUS, INFORMATION PROCESSING METHOD, AND PROGRAM

(71) Applicant: SONY GROUP CORPORATION, Tokyo (JP)

(72) Inventors: Yuji HORIGUCHI, Kanagawa (JP); Shingo TAKAMATSU, Tokyo (JP); Kento NAKADA, Tokyo (JP); Masanori MIYAHARA, Tokyo (JP); Hiroshi IIDA, Tokyo (JP)

(73) Assignee: SONY GROUP CORPORATION, Tokyo (JP)

(21) Appl. No.: 17/792,583

(22) PCT Filed: Feb. 4, 2021
(86) PCT No.: PCT/JP2021/004146

§ 371 Date: Jul. 13, 2022

(30) Foreign Application Priority Data
Feb. 14, 2020 (JP) 2020-023738

(51) Int. Cl. G06N 5/02; G06N 5/00

(52) U.S. Cl. CPC G06N 5/022; G06N 5/003

(57) ABSTRACT

An information processing apparatus according to an embodiment of the present technology includes a first learning unit, a second learning unit, an evaluation unit, and an adjustment unit. The first learning unit causes a predetermined learning model to perform learning. The second learning unit causes a conversion model to perform learning, the conversion model converting an output of the predetermined learning model into a rule group described in a format that can be interpreted by a user. The evaluation unit acquires evaluation information obtained by evaluating the rule group in accordance with a predetermined standard. The adjustment unit adjusts learning processing of the predetermined learning model on the basis of the evaluation information.

### TECHNICAL FIELD

The present technology relates to an information processing apparatus, an information processing method, and a program that are applicable to the construction of a learning model using machine learning.

### BACKGROUND ART

Conventionally, a technique for confirming whether a processing result using a computer violates laws and regulations has been known. For example, Patent Literature 1 describes an ethics examination support system that supports an examination of whether or not the contents of video data violate ethical codes. In this system, for example, the level of various parameters (color of blood, frequency, etc.) relating to a video representation is analyzed to determine whether or not the video data violates the ethical codes. Thus, automatically analyzing the video representation by the system makes it possible to obtain an objective examination result (paragraphs [0046], [0051], [0056], and others of Patent Literature 1).

In recent years, techniques for predicting various objects or techniques for performing image recognition and the like by a learning model using machine learning have also been developed. Using the learning model, for example, it is possible to predict whether or not to employ a person who comes to a company for an interview, or to predict the expected length of service of a person who comes for an interview. If such a prediction is performed, it is important to confirm whether or not the processing by the model satisfies necessary standards such as laws and regulations.

### CITATION LIST

### Patent Literature

Patent Literature 1: Japanese Patent Application Laid-open No. 2002-149884

### DISCLOSURE OF INVENTION

### Technical Problem

Learning models using machine learning are expected to be applied in various scenes. There is a demand for a technique capable of easily constructing a learning model that satisfies necessary standards.

In view of the above circumstances, it is an object of the present technology to provide an information processing apparatus, an information processing method, and a program that are capable of easily constructing a learning model satisfying necessary standards.

### Solution to Problem

In order to achieve the above object, an information processing apparatus according to an embodiment of the present technology includes a first learning unit, a second learning unit, an evaluation unit, and an adjustment unit.

The first learning unit causes a predetermined learning model to perform learning.

The second learning unit causes a conversion model to perform learning, the conversion model converting an output of the predetermined learning model into a rule group described in a format that can be interpreted by a user.

The evaluation unit acquires evaluation information obtained by evaluating the rule group in accordance with a predetermined standard.

The adjustment unit adjusts learning processing of the predetermined learning model on the basis of the evaluation information.

In this information processing apparatus, the learning processing of the predetermined learning model and the learning processing of the conversion model that converts the output of the predetermined learning model are performed. The conversion model converts the output of the learning model into a rule group described in a format that can be interpreted by a user. The learning processing of the learning model is adjusted by using the evaluation information obtained by evaluating the rule group in accordance with a predetermined standard. This makes it possible to easily construct a learning model that satisfies a necessary standard.

The predetermined standard may include at least one of a standard defined by law or a standard defined by the user.

The learning model may be a prediction model for predicting a target item.

The rule group may include at least one output rule describing an output of the prediction model. In this case, the evaluation unit may generate at least one of an explanatory sentence or a chart relating to each of the output rules.

The evaluation unit may generate a check item for causing the user to check whether or not each of the output rules satisfies the predetermined standard.

The evaluation unit may read, as the evaluation information, a check result of the check item by the user.

The evaluation unit may generate the check item of a data item specified by the user among a plurality of data items included in learning data of the prediction model.

The information processing apparatus may further include a storage unit that stores a database relating to the predetermined standard. In this case, the evaluation unit may determine whether or not the output rule satisfies the predetermined standard on the basis of the database.

The evaluation unit may generate a check item for the output rule determined as failing to satisfy the predetermined standard, the check item causing the user to check whether or not the output rule satisfies the predetermined standard.

The evaluation unit may generate, as the evaluation information, information relating to the output rule determined as failing to satisfy the predetermined standard.

The evaluation information may include information relating to a violation rule that is the output rule failing to satisfy the predetermined standard. In this case, the adjustment unit may adjust at least one of learning data of the prediction model or a learning parameter of the prediction model with reference to a data range specified by the violation rule.

The adjustment unit may perform at least one of processing to reduce the number of pieces of the learning data that causes the violation rule failing to satisfy the predetermined standard, in the learning data included in the data range specified by the violation rule, or processing to add dummy data as the learning data to the data range specified by the violation rule, the dummy data being adjusted to satisfy the predetermined standard.

The learning parameter may include at least one of a parameter for adjusting the output of the prediction model relating to the learning data or a parameter for adjusting a loss function of the prediction model.

The prediction model may be a classification model using a classification relating to the target item as a predicted value. In this case, the adjustment unit may adjust learning processing of the prediction model such that the predicted value of the prediction model in the data range specified by the violation rule substantially matches the predicted value of the prediction model in a data range specified by the output rule that satisfies the predetermined standard.

The prediction model may be a regression model using a value of the target item as a predicted value. In this case, the adjustment unit may adjust learning processing of the prediction model such that a distribution of the predicted value of the prediction model in the data range specified by the violation rule substantially matches a distribution of the predicted value of the prediction model in a data range specified by the output rule that satisfies the predetermined standard.

The evaluation unit may present a plurality of adjustment methods relating to an output of the prediction model in a selectable manner. In this case, the adjustment unit may adjust learning processing of the prediction model on the basis of a method selected by the user among the plurality of adjustment methods.

The second learning unit may cause the conversion model to perform learning, the conversion model conforming to the predetermined standard.

The conversion model may be a learning model using at least one algorithm of a decision tree or a rule fit.

An information processing method according to an embodiment of the present technology includes: causing a predetermined learning model to perform learning; causing a conversion model to perform learning, the conversion model converting an output of the predetermined learning model into a rule group described in a format that can be interpreted by a user; acquiring evaluation information obtained by evaluating the rule group in accordance with a predetermined standard; and adjusting learning processing of the predetermined learning model on the basis of the evaluation information, which are executed by a computer system.

A program according to an embodiment of the present technology causes a computer system to execute the steps of: causing a predetermined learning model to perform learning; causing a conversion model to perform learning, the conversion model converting an output of the predetermined learning model into a rule group described in a format that can be interpreted by a user; acquiring evaluation information obtained by evaluating the rule group in accordance with a predetermined standard; and adjusting learning processing of the predetermined learning model on the basis of the evaluation information.

### BRIEF DESCRIPTION OF DRAWINGS

FIG. 1 is a schematic diagram for describing the outline of an operation of a data analysis apparatus according to an embodiment of the present technology.

FIG. 2 is a block diagram showing an example of a configuration of the data analysis apparatus.

FIG. 3 is a table showing an example of a learning database.

FIG. 4 is a table showing an example of a rule database.

FIG. 5 is a schematic diagram for describing a summary model.

FIG. 6 is a flowchart showing an example of the basic operation of the data analysis apparatus.

FIG. 7 is an example of a UI screen that specifies learning data to be used in the prediction model.

FIG. 8 is an example of a UI screen for inputting various settings relating to the prediction model.

FIG. 9 is an example of an evaluation screen for displaying the characteristics of the prediction model.

FIG. 10 is another example of an evaluation screen for displaying the characteristics of the prediction model.

FIG. 11 is an example of a check screen about an output rule.

FIG. 12 is another example of a check screen about an output rule.

FIG. 13 is an example of a check screen displayed when a regression model is used.

FIG. 14 is a map of the output of a prediction model described as a comparative example.

FIG. 15 is an example of a check screen displayed when an authentication model is used.

### MODE(S) FOR CARRYING OUT THE INVENTION

An embodiment according to the present technology will be described below with reference to the drawings.

[Configuration of Data Analysis Apparatus]

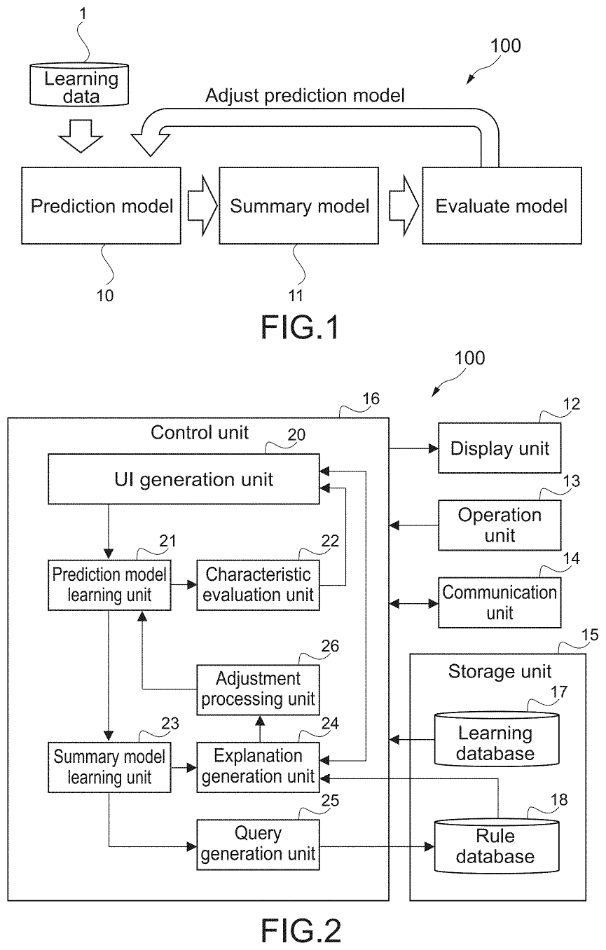

FIG. 1 is a schematic diagram for describing the outline of an operation of a data analysis apparatus 100 according to an embodiment of the present technology. The data analysis apparatus 100 is configured using a computer or the like and provides a prediction analysis tool for performing a prediction analysis or the like.

Here, the prediction analysis is a technique for predicting future events on the basis of past cases by, for example, machine learning. In the prediction analysis, a prediction model 10 constructed to correspond to a prediction target is used. Using the prediction analysis (prediction model 10), it is possible to predict whether or not a new person who has come for an employment interview should be employed with the results of the past employment interviews, for example. Of course, the target of the prediction analysis is not limited and can be arbitrarily set. In this embodiment, the prediction model 10 is an example of a predetermined learning model.

A user who uses the data analysis apparatus 100 can construct a prediction model 10 for predicting a desired item by specifying learning data 1, an input item, a parameter of the model, and the like via a graphical user interface (GUI) displayed on a display (not shown) or the like, for example.

FIG. 1 schematically shows the flow of a basic operation performed by the data analysis apparatus 100 when the prediction model 10 is constructed.

As shown in FIG. 1, the data analysis apparatus 100 performs the steps of constructing a prediction model 10, constructing a summary model 11, evaluating the model, and adjusting the prediction model 10.

The summary model 11 is a learning model that converts the output of the prediction model 10 into a format that can be interpreted by a user. In this embodiment, the summary model 11 corresponds to a conversion model.

In general, since the processing content of the prediction model 10 using machine learning is complicated, for example, it is often difficult to extract a rule (condition) or the like representing the output of the prediction model 10 from the output thereof. For example, by only looking at the distribution of the prediction results represented by the output of the prediction model 10, it is difficult to interpret a condition or the like of the data applying to the prediction results.

The summary model 11 generates a rule group obtained by summarizing (approximating) such a complicated output. Here, the rule group means a set of rules including at least one rule describing the output of the prediction model 10. Those rules are described using, for example, conditions that can be interpreted by the user. This makes it possible to easily interpret the contents even when the output is complicated. Hereinafter, a rule for describing the output of the prediction model 10 will be referred to as an output rule.

The step of evaluating the model is a step of confirming whether or not the prediction processing by the prediction model 10 satisfies a predetermined standard. In the data analysis apparatus 100, the output of the prediction model 10 is evaluated on the basis of the rule group generated by the summary model 11, that is, the rule group obtained by summarizing the output of the prediction model 10.

The predetermined standard includes the standards stipulated by laws and regulations. For example, in a situation such as predicting whether or not a person who has come to a company for an employment interview is to be employed, the output (rule group) of the prediction model 10 is evaluated in accordance with the standards stipulated by the Equal Employment Opportunity Act.

Further, the predetermined standard may include a standard determined by the user. For example, even in the case of predicting the employment of an interviewee, it may be favorable not to use the standards stipulated by laws and regulations as they are, depending on the situation of the company (gender composition, age composition, etc. of employees). In such a case, the rule group may be evaluated in accordance with the standards set by the user according to the situation (determination by the user, etc.).

The data analysis apparatus 100 generates information obtained by evaluating the rule group (output rule) in accordance with the predetermined standard. The information obtained by evaluating the rule group includes, for example, information indicating a determination result as to whether or not each output rule satisfies a predetermined standard, the degree of deviation of the output rule from a predetermined standard, and the like.

Further, the determination on whether or not each output rule satisfies a predetermined standard may be performed by the user or may be automatically performed by the data analysis apparatus 100 (explanation generation unit 24 to be described later).

Hereinafter, the information obtained by evaluating the rule group in accordance with the predetermined standard will be described as evaluation information. The evaluation information can be referred to as information indicating whether or not the output of the prediction model 10 satisfies a predetermined standard.

In the step of adjusting the prediction model 10, the learning processing of the prediction model 10 is adjusted on the basis of the evaluation information. Specifically, the learning processing of the prediction model 10 is adjusted such that the output of the prediction model 10 satisfies a predetermined standard, that is, such that an output rule that does not satisfy a predetermined standard is not extracted from the output of the prediction model 10. Repeating the adjustment of the learning processing in such a manner makes it possible to construct the prediction model 10 that satisfies a predetermined standard. The method of adjusting the learning processing will be described later in detail.

For example, in a state in which the output of the prediction model 10 does not satisfy a predetermined standard, there may be a case where the prediction by the prediction model 10 has an ethical problem or lacks the fairness. For example, the prediction model 10 in which a predicted value such as an employment rate is biased depending on the gender or age may fall under an ethics violation.

In the data analysis apparatus 100, two learning models of the “prediction model 10” and the “summary model 11” that summarizes the prediction model 10 are prepared, and whether or not the output of the “prediction model 10” has an ethical problem is confirmed using the “summary model 11”. The “prediction model 10” is then adjusted using the confirmation result. Therefore, using the data analysis apparatus 100 makes it possible to confirm whether or not the prediction model 10 has an ethical problem or the like and to correct the problem if there is a problem.

As a result, even a user who does not understand the algorithm of the prediction model 10 can easily confirm whether or not the output of the prediction model 10 has an ethical problem or the like.

Further, it is possible to correct the output of the prediction model 10 for a part having an ethical problem or the like in the output thereof through the summary model 11.

Furthermore, it is possible to automatically confirm whether or not the prediction model 10 has an ethical problem or the like, and it is also possible to correct a problem or the like that the user does not notice.

As a result, it is possible to easily construct a prediction model 10 that satisfies a necessary standard.

FIG. 2 is a block diagram showing a configuration example of the data analysis apparatus 100. The data analysis apparatus 100 includes a display unit 12, an operation unit 13, a communication unit 14, a storage unit 15, and a control unit 16.

The display unit 12 is a display for displaying each piece of information and displays, for example, the above-mentioned GUI screen. For example, a liquid crystal display (LCD) or an organic electro-luminescence (EL) display is used as the display unit 12. The specific configuration of the display unit 12 is not limited. For example, a display equipped with a touch panel or the like that functions as the operation unit 13 may be used. Further, a head mounted display (HMD) may be used as the display unit 12.

The operation unit 13 includes an operation device for the user to input various types of information. For example, a device capable of inputting information, such as a mouse, a keyboard, or a track pad, is used as the operation unit 13. In addition, the specific configuration of the operation unit 13 is not limited. For example, a touch panel or the like may be used as the operation unit 13. Further, a camera for imaging a user or the like may be used as the operation unit 13, so that an input can be performed using a line of sight or a gesture.

The communication unit 14 is a module that performs communication processing between another apparatus and the data analysis apparatus 100. The communication unit 14 includes, for example, a wireless local area network (LAN) module such as a Wi-Fi, or a wired LAN module. In addition, communication modules capable of short-range radio communication such as Bluetooth (registered trademark), optical communication, or the like may be used.

The storage unit 15 is a nonvolatile storage device, and for example, a hard disk drive (HDD), a solid-state drive (SSD), or the like is used. The storage unit 15 stores a learning database 17 and a rule database 18. Further, the storage unit 15 functions as a storage unit of the data analysis apparatus 100, and stores programs or the like to be executed by the control unit 16.

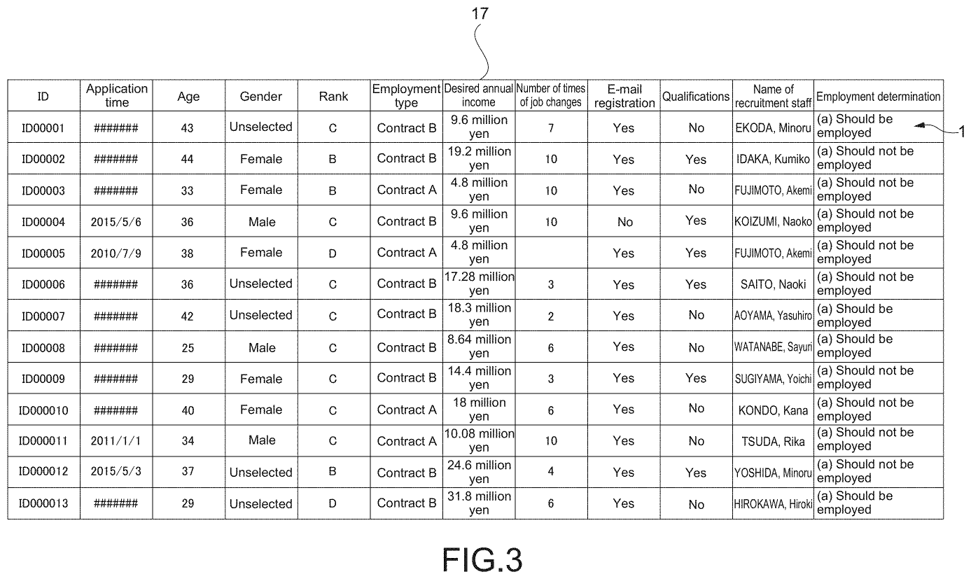

FIG. 3 is a table showing an example of the learning database 17. The learning database 17 is a database in which the learning data 1 for performing learning (training) of the prediction model 10 is stored.

In the example shown in FIG. 3, the personnel data relating to the applicants for employment who were subjected to employment determination in the past is used as the learning data 1.

Each piece of learning data 1 includes the items of ID, application period, age, gender, rank, employment type, desired annual income, number of times of job changes, presence or absence of e-mail registration, presence or absence of qualifications, recruitment staff, and a result of employment determination of each applicant for employment.

For example, when the prediction model 10 for determining whether to employ is caused to perform learning, the result of the employment determination is a target item to be learned. Further, the items other than the target item (the result of the employment determination) of the prediction model 10 are parameters to be used for learning of the prediction model 10.

The learning database 17 is a set of such pieces of learning data 1 and is recorded as, for example, data in the CSV format. In addition, the format and the like of the learning data 1 are not limited.

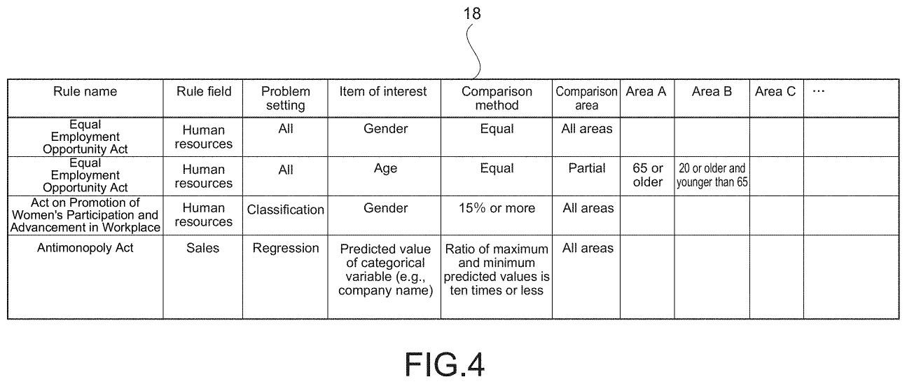

FIG. 4 is a table showing an example of the rule database 18. The rule database 18 is a database in which information relating to laws and regulations and information relating to other rules such as general ethical standards (hereinafter, referred to as evaluation rules) are stored.

In this embodiment, the laws and regulations and the evaluation rules are examples of the predetermined standards. Further, the rule database corresponds to a database relating to the predetermined standards.

As shown in FIG. 4, the rule database 18 includes items such as a rule name, a rule field, problem setting, an item of interest, a comparison method, a comparison area, and details of area (area A, area B, . . . ). The rule database 18 is configured as table data in the CSV format, for example.

In the item of the rule name, the names of the laws and regulations, the evaluation rules, and the like, the descriptions thereof, and the like are input.

In the item of the rule field, the field to which a rule is applied (for example, the field of human resources, the field of sales, the field of insurance, etc.) is input.

In the item of the problem setting, the type of problem to be solved by the prediction model 10, such as classification, regression, or object recognition, is recorded. For example, if “all” is input in the item of the problem setting, it means that the relevant laws and regulations are rules to be observed regardless of the type of the prediction model 10. Further, if “classification” is input in the item of the problem setting, it means that the relevant laws and regulations are rules to be observed when the prediction model 10 solves a classification problem.

In the item of interest, the items of target (e.g., age, gender, etc.) stipulated by the laws and regulations and the evaluation rules are input. In other words, the item of interest is an item that specifies the matter stipulated by the laws and regulations.

In the item of the comparison method, a comparison method for the item of interest is input. For example, if the comparison method is input as “equal”, it means that the item of interest (gender or age) should be treated equally. In this case, whether the predicted value is biased or not is compared for each gender or age.

In the item of the comparison area, an area to be compared is input. For example, if the item of interest is age, information for specifying a comparison for all ages or a comparison for some ages is input.

In the item of the details of area, information for dividing the area is input when the item of interest is divided more finely for comparison.

The rule database 18 is a set of such laws and regulations and evaluation rules and is recorded as data in the CSV format, for example. In addition, the format and the like of the rule database 18 are not limited.

Returning to FIG. 2, the control unit 16 controls the operation of each block included in the data analysis apparatus 100. The control unit 16 has a hardware configuration required for a computer, such as a CPU or a memory (RAM, ROM), and functions as an information processing apparatus according to this embodiment. The CPU loads a program stored in the storage unit 15 to the RAM and executes it, thus executing various types of processing. For example, devices, e.g., a programmable logic device (PLD) such as a field programmable gate array (FPGA), and an application specific integrated circuit (ASIC) may be used as the control unit 16.

In this embodiment, the CPU of the control unit 16 executes the programs according to this embodiment, so that a UI generation unit 20, a prediction model learning unit 21, a characteristic evaluation unit 22, a summary model learning unit 23, an explanation generation unit 24, a query generation unit 25, and an adjustment processing unit 26 are implemented as functional blocks. The information processing method according to this embodiment is then executed by those functional blocks. Note that dedicated hardware such as an integrated circuit (IC) may be used as appropriate in order to implement each functional block.

The UI generation unit 20 generates a UI screen (display interface) to be displayed on the display unit 12. Typically, the UI generation unit 20 generates a GUI such as a UI screen displayed when the prediction analysis using the prediction model 10 is performed.

On the UI screen, for example, information to be presented to the user, an entry field for the user to input information, and the like are displayed. The user can specify various settings, values, and the like by operating the operation unit 13 (such as a keyboard) while viewing the UI screen.

Further, the UI generation unit 20 receives the information input and specified by the user through the UI screen. The information input through the UI screen includes, for example, information for specifying learning data to be used, information relating to a field to which the prediction model 10 is applied (human resources, sales, insurance, etc.), a type of problem setting (classification, regression, etc.), an item of interest (age, gender, etc.), and the like. Check items to be described later are displayed on the UI screen displayed after the prediction model 10 is generated. Check results of the check items and the like are received through the UI screen.

As described above, the UI generation unit 20 implements a display function on the UI screen for processing a screen input, and a data input/output function through the UI screen.

The prediction model learning unit 21 causes the prediction model 10 for predicting a target item to perform learning. The learning processing of the prediction model 10 is processing in which, for example, a learning model designed to predict a target item specified by a user is caused to perform learning using a plurality of pieces of learning data 1.

Typically, the prediction model 10 is configured by using a machine learning algorithm (decision tree learning, neural network, or the like), which performs learning using the learning data 1 in which a feature item (weather, day of week, gender, age, and the like) and a target item (a value to be predicted) are paired. Therefore, it can be said that the prediction model learning unit 21 performs supervised learning for training a model by using the predicted value of the learning data 1 as supervised data.

The target item, the algorithm used in the prediction model 10, the learning data 1 to be used, and the like are input through the above-mentioned UI screen and the like.

In such a manner, the prediction model learning unit 21 implements a prediction model creation function. In this embodiment, the prediction model learning unit 21 corresponds to a first learning unit.

In this embodiment, a classification model using the classification of the target item as a predicted value is used as the prediction model 10. For example, if the target item is an item indicating whether or not a subject is to be employed, whether or not the subject is to be employed is predicted. Further, for example, if the target item is an item indicating whether or not a commodity is to be purchased, whether or not the customer purchases the product is predicted. In addition, the prediction model 10 capable of solving any classification problem including a plurality of options may be used.

Further, a regression model in which the value of the target item is a predicted value may be used as the prediction model 10. For example, if the target item is the length of service of the subject, the expected length of service of the subject is predicted. Further, for example, if the target item is the date of withdrawal of a service, the date of withdrawal or the like on which the customer is supposed to withdraw from the service is predicted.

Note that the algorithm of machine learning and the like used in the prediction model 10 are not limited, and for example, any algorithm corresponding to the processing contents may be used as appropriate. The present technology is applicable regardless of the type of algorithm or the like.

If the prediction model 10 is generated for the first time or if it is evaluated that the prediction model 10 has no ethical problems or the like, the prediction model learning unit 21 performs normal supervised learning for training the prediction model 10, such as applying a recorded correct solution to the learning data 1.

Further, if the prediction model 10 has an ethical problem (e.g., if the user points out a rule violation or an ethical violation), the learning processing of the prediction model 10 is adjusted. Specifically, the prediction model learning unit 21 changes the learning data 1 used for the learning processing, the learning parameters set for each algorithm, and the like in accordance with an adjustment instruction generated by the adjustment processing unit 26 to be described later, and causes the prediction model 10 to perform learning again.

The prediction model learning unit 21 receives inputs of the learning data 1 to be passed to the prediction model 10, the setting data, and the adjustment instruction generated by the adjustment processing unit 26. Further, the prediction model learning unit 21 outputs the created prediction model 10.

The characteristic evaluation unit 22 evaluates the characteristics of the prediction model 10. Specifically, an evaluation index indicating the performance of the prediction model 10, the tendency of prediction, or the like is calculated.

For example, if the prediction model 10 is a classification model, the rate of correct solutions, the degree of accuracy, or the like of the predicted value is calculated as an evaluation index. Further, if the prediction model 10 is a regression model, an error average, a squared error, or the like of the predicted value is calculated as an evaluation index. The type of the evaluation index is not limited. For example, an evaluation index corresponding to the type of algorithm of the prediction model 10 may be calculated as appropriate.

The created prediction model 10 is input to the characteristic evaluation unit 22. Further, various evaluation indices and the like are output from the characteristic evaluation unit 22.

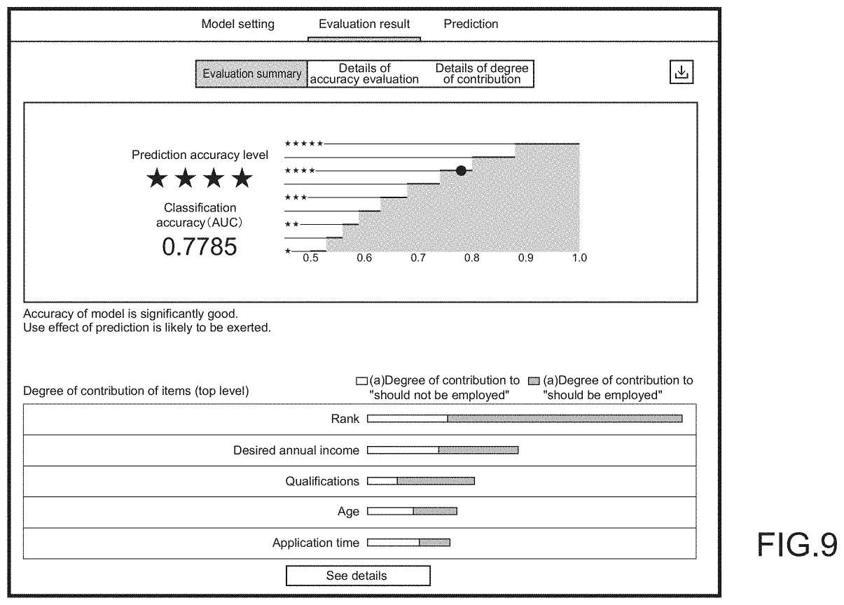

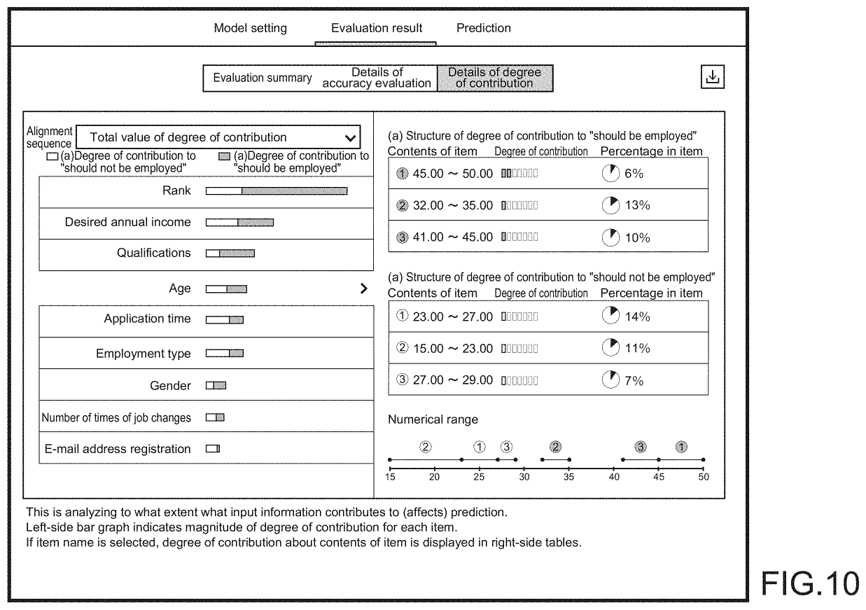

Note that the evaluation index of the prediction model 10 is displayed on, for example, the UI screen and presented to the user (see FIGS. 9 and 10). As a result, the user can grasp the performance of the prediction model 10.

The summary model learning unit 23 causes the summary model 11 to perform learning, the summary model 11 converting the output of the prediction model 10 into a rule group described in a format that can be interpreted by the user.

As described with reference to FIG. 1, the summary model 11 is a learning model that outputs, as a rule group, at least one output rule describing the output of the prediction model 10.

The created prediction model 10 is input to the summary model learning unit 23. Further, the created summary model 11 is output from the summary model learning unit 23.

In this embodiment, the summary model learning unit 23 corresponds to a second learning unit.

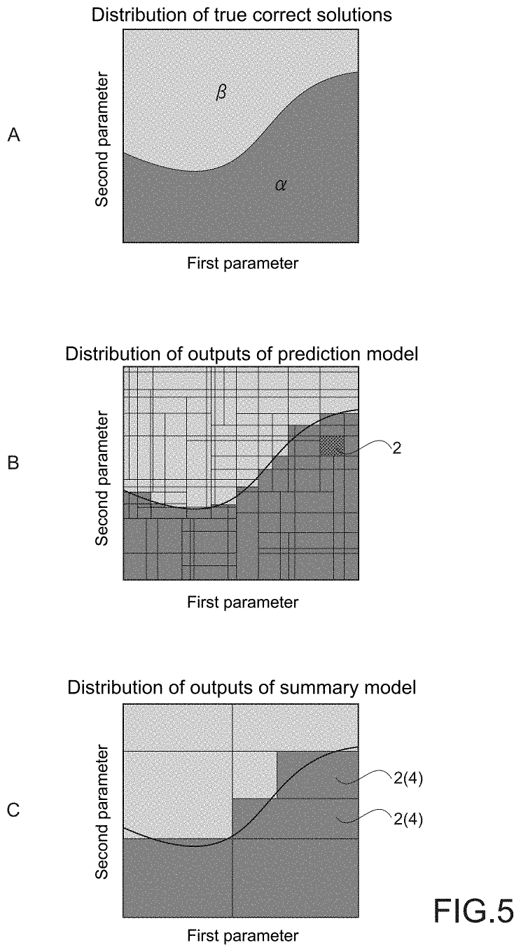

FIG. 5 is a schematic diagram for describing the summary model 11. Here, it is assumed that a classification model is used as the prediction model 10, and the summary model 11 that summarizes the output of the classification model will be described.

A of FIG. 5 is a map showing the distribution of true correct solutions of the data input to the prediction model 10 (the learning data 1 or the like). In this map, the item to be classified is classified into a category α (a dark gray area at the bottom of the map) and a category β (a light gray area at the top of the map). Further, the horizontal axis and the vertical axis of the map are a first parameter and a second parameter relating to the item to be classified. Note that three or more parameters may be set.

A case will be described as an example in which a prediction model 10 (classification model) for predicting whether to employ subjects or not is used. In this case, the categories α and β represent cases where the subjects are to be employed and where the subjects are not to be employed, respectively. Further, the horizontal axis of the map (the first parameter) represents the age of the subjects, and the vertical axis of the map (the second parameter) represents the annual income desired by the subjects.

In this case, in the map shown in A of FIG. 5, for example, if the desired annual income is sufficiently high, the subjects are not to be employed regardless of the age. Further, if the age is sufficiently high, the subjects are to be employed even if the desired annual income is relatively high.

The prediction model 10 is trained to be able to predict, for example, the distribution represented by such true correct solutions on the basis of the first parameter, the second parameter, and the like.

B of FIG. 5 is a map showing the distribution of prediction results (outputs) of the prediction model 10. The area divided into a rectangle on the map is a conditional area 2 that is described using conditions relating to the first and second parameters. For example, specifying the ranges of the first and second parameters is to specify one conditional area 2.

As shown in B of FIG. 5, the actual prediction model 10 performs prediction processing for classification into the categories α and β for each of a large number of conditional areas 2. In other words, each conditional area 2 is classified into the category α or the category β. Therefore, it can be said that the border of the conditional areas 2 having different categories becomes a decision border when the prediction model 10 performs classification. Here, the decision border is a reference plane for determining the change of prediction. For example, in the case of an employment prediction, the difference between “employ” and “not employ” becomes the decision border.

As described above, since the conditional areas 2 are sufficiently fine in the actual prediction model 10, the distribution of true correct solutions shown in A of FIG. 5 can be reproduced with high accuracy. On the other hand, the conditions relating to the respective parameters become too complicated, which makes difficult to interpret information of classification such as a correspondence between data, area, and category.

C of FIG. 5 is a map showing the distribution of the output of the summary model 11. The summary model 11 is caused to perform learning so as to obtain an output as close to the prediction model as possible. As a result, the output of the summary model 11 becomes a conditional area 2 that approximates the conditional area 2 of the prediction model 10 and covers a wider area (data range). Each of the approximated conditional areas 2 corresponds to an output rule 4 that describes the output of the prediction model 10 so as to be interpretable.

For example, in C of FIG. 5, the areas classified into the category α are represented by four conditional areas 2 (output rules 4). As a result, for example, the output of the prediction model 10 can be described as four types of conditions described in the ranges of the first and second parameters.

Hereinafter, the conditional area 2 specified by the output rule 4 may be simply described as an area specified by the output rule. In this embodiment, the conditional area corresponds to a data range.

Examples of the method of constructing such a summary model 11 include a method using an algorithm such as a decision tree or a rule fit. In other words, the summary model 11 is a learning model using at least one algorithm of a decision tree or rule fit.

By using a decision tree or rule fit, the output of the complicated prediction model 10 can be described in a brief condition (output rule 4).

Further, the summary model learning unit 23 may cause the summary model 11 to perform learning in accordance with a predetermined standard for evaluating the output of the prediction model 10. For example, if the predetermined standards are laws and regulations in which the standard for age is set, the summary model 11 is configured to generate the output rule 4 described with the age as a parameter. In this case, for example, the output rule 4 combining a condition specifying an age range and a condition described with other parameters (gender, desired annual income, and the like), and the like are generated.

This makes it possible to easily determine whether or not the output of the prediction model 10 satisfies a predetermined standard, for example.

In addition, the specific configuration of the summary model 11 is not limited. For example, any algorithm capable of summarizing the output of the prediction model 10 may be used in accordance with the algorithm used in the prediction model 10 or the like.

Returning to FIG. 2, the explanation generation unit 24 generates information describing each of the output rules 4 (rule group) generated by the summary model 11.

Further, the explanation generation unit 24 acquires evaluation information obtained by evaluating the rule group in accordance with a predetermined standard. In this embodiment, the explanation generation unit 24 corresponds to an evaluation unit.

Specifically, the explanation generation unit 24 generates an explanatory sentence regarding each of the output rules 4. The explanatory sentence is displayed on the UI screen by the UI generation unit 20.

For example, if an algorithm of a decision tree or the like is used as the summary model 11, the output rule 4 of the prediction model 10 can be described as a set of a plurality of simple rules. The explanation generation unit 24 generates an explanatory sentence representing such a set of rules.

For example, suppose that a rule is generated as the output rule 4, in which a subject is to be employed when following conditions are satisfied: the gender item is “male”, the age item is “45 or older”, and the qualification item is “qualification retention”. In this case, the explanation generation unit 24 generates an explanatory sentence such as “employing a subject who is male and 45 years old or older and has qualifications”.

Such an explanatory sentence is generated for each output rule 4, for example.

A chart for each of the output rules 4 may also be generated. For example, the above-mentioned contents of the conditions relating to gender, age, qualification, and the like may be illustrated as an image on the map described with reference to FIG. 3 and the like. This makes it possible to describe the output rule 4 in an intuitive and easy-to-understand manner. Alternatively, a table or the like indicating conditions relating to each item may be generated. This makes it possible to easily grasp the difference between the plurality of output rules 4, for example.

In addition, the explanation generation unit 24 can generate information describing the output rule 4 in various formats in accordance with an algorithm used in the summary model 11 that summarizes the prediction model 10.

In this embodiment, the explanation generation unit 24 generates, for each of the output rules 4, a check item that allows the user to check whether or not a predetermined standard is satisfied. Examples of the check item to be used include an explanatory sentence generated such that the user can determine whether or not a corresponding output rule 4 satisfies a predetermined standard. The generated check item is output to the UI generation unit 20 and displayed on the UI screen.

The check item is generated for the item of interest specified by the user, for example. In other words, a check item is generated using an explanatory sentence or the like, from which whether or not the item specified by the user satisfies a predetermined standard can be determined.

Further, a check item may be generated after determining whether or not each output rule 4 satisfies a predetermined standard on the basis of the rule database. In this case, for example, a check item for requesting the user to confirm the output rule 4, for which the explanation generation unit 24 determines that the predetermined standard is not satisfied, is generated. The method of generating the check item will be described in detail later.

Further, the explanation generation unit 24 reads the user's check result of the check item. This check result is an example of evaluation information obtained by evaluating a rule group in accordance with a predetermined standard.

For example, it is assumed that, for a certain output rule 4, the user determines that a predetermined standard is not satisfied, and a check item 5 thereof is checked. In this case, the checked output rule 4 is a violation rule that does not satisfy a predetermined standard. Hence, the evaluation information includes information for specifying the output rule 4, which has been determined as a violation rule by the user.

In addition, the explanation generation unit 24 generates, as evaluation information, information specifying laws and regulations that are not satisfied by the violation rule, information indicating the degree of deviation of the violation rule from the standard, and the like in association with the violation rule. Thus, the evaluation information includes information relating to the violation rules, which are output rules 4 that do not satisfy a predetermined standard.

As described above, the explanation generation unit 24 receives information relating to the created summary model 11 and the item of interest specified by the user, or information relating to the laws and regulations acquired from the rule database. Further, the explanation generation unit 24 outputs an explanatory sentence (check item) of the output rule 4 to be presented to the user, and evaluation information about each output rule.

The query generation unit 25 generates a query for inquiring information such as laws and regulations necessary for evaluating the prediction model 10 from the rule database 18. The query can also be said to be a command for collecting laws and regulations that the prediction model 10 must comply with.

For example, a query is generated via the UI screen by the user on the basis of the field to which the prediction model 10 is applied, the type of problem setting, and the information of the item of interest. Alternatively, a query for inquiring laws and regulations to be referred to may be generated in accordance with the output rule 4 or the like generated by the summary model 11.

The query generation unit 25 receives information such as the created summary model 11 or the item of interest specified by the user. Further, a query for inquiring laws and regulations is output from the query generation unit 25.

For example, if the laws and regulations relating to the age and gender are examined in the prediction model 10 for predicting employment, the following query is generated.

Query: (Field=Human Resources, Problem Setting=Classification, Item of Interest=(Age, Gender))

Of course, the form of the query and the like are not limited.

When such a query is input to the rule database 18, a rule is acquired, in which the item of the rule field is “Human Resources”, the item of the problem setting is “Classification” or “All”, and the item of interest is “Age” or “Gender”. For example, in FIG. 4, information relating to the Equal Employment Opportunity Act and the Act on Promotion of Women's Participation and Advancement in the Workplace is acquired.

In such a manner, the query for inquiring laws and regulations is input to the rule database 18. Further, information such as the laws and regulations corresponding to the specified query is output from the rule database 18.

The adjustment processing unit 26 adjusts the learning processing of the prediction model 10 on the basis of the evaluation information. More specifically, the adjustment processing unit 26 adjusts the learning processing of the prediction model 10 by generating an adjustment instruction for adjusting the prediction model 10 on the basis of the evaluation information. In this embodiment, the adjustment processing unit 26 corresponds to an adjustment unit.

Examples of the method of adjusting the prediction model 10 include a method of adjusting the learning data 1 or a learning parameter. For example, if the learning data 1 is adjusted, information specifying the target learning data 1, information indicating a method of handling the learning data 1, and the like are generated as adjustment instructions. In addition, for example, if a learning parameter is adjusted, information specifying a target learning parameter, information indicating an adjustment amount of the learning parameter, and the like are generated as adjustment instructions.

Those adjustment instructions are set in accordance with the contents of the violation or the like such that the violation rule specified by the evaluation information disappears, for example.

Thus, the evaluation information output from the explanation generation unit 24 is input to the adjustment processing unit 26. Further, an adjustment instruction for adjusting the prediction model 10 is output from the adjustment processing unit 26.

Note that the adjustment processing unit 26 may be configured as a part of the prediction model learning unit 21, for example. In other words, it is also possible to provide a configuration in which the prediction model learning unit 21 adjusts the learning processing of the prediction model 10 on the basis of the evaluation information.

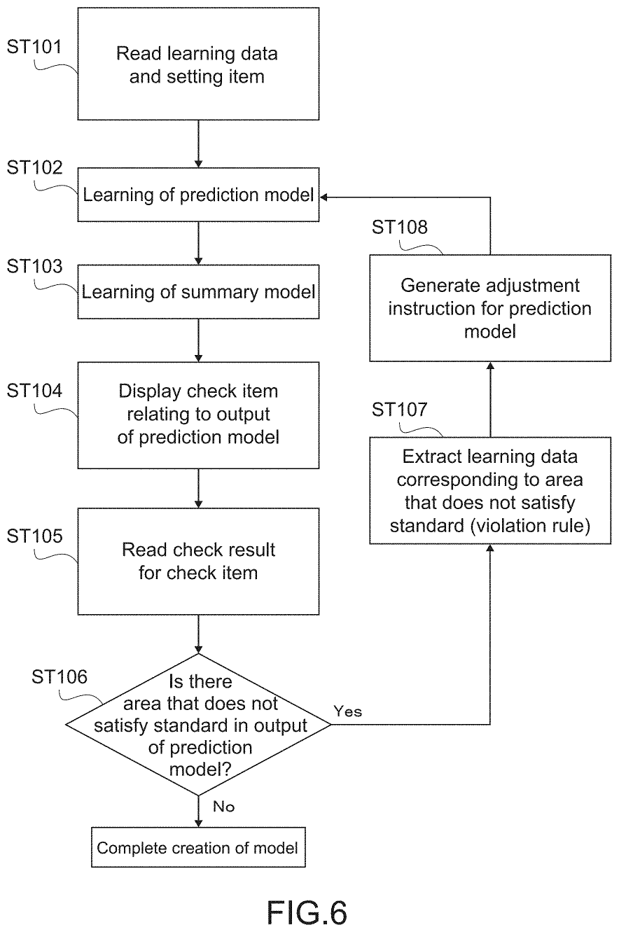

FIG. 6 is a flowchart showing an example of the basic operation of the data analysis apparatus 100. The processing shown in FIG. 6 is executed before the user completes the prediction model 10, for example.

Hereinafter, the basic operation of the data analysis apparatus 100 will be described using an example of a classification model for predicting whether or not to employ a subject as the prediction model 10. Needless to say, the following description is applicable regardless of the type, target, or the like of the prediction model 10.

Information relating to the learning data 1 and the setting items, which are input through the UI screen, are read (Step 101).

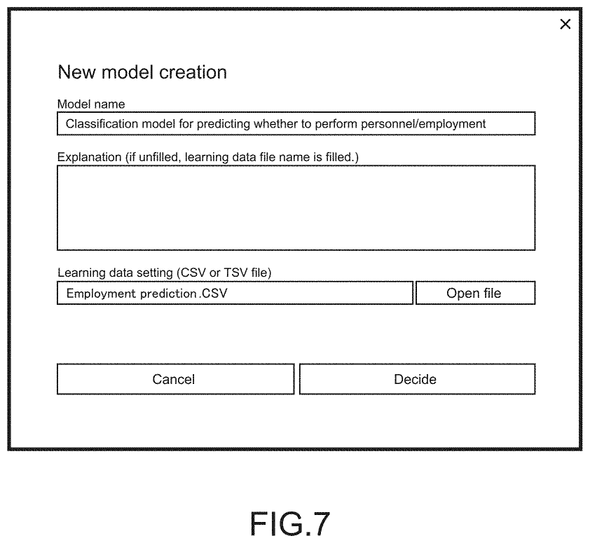

FIG. 7 is an example of a UI screen for specifying the learning data 1 to be used in the prediction model 10. The UI screen shown in FIG. 7 is a start screen displayed when, for example, the user starts generating the prediction model 10.

The start screen includes an entry field of “model name” for inputting the name of the prediction model 10 to be created and an entry field of “explanation” for inputting the explanation of the prediction model 10.

The start screen also includes an entry field of “learning data setting” for specifying the learning data 1 (learning database 17) to be used for learning of the prediction model 10. Here, it is instructed to specify a CSV format or TSV format file as the learning data 1. For example, the learning data 1 to be used is specified by dragging a file to be used as the learning data 1 onto the start screen or by selecting it from the folder tree.

When the OK button is pressed after the necessary information is input in each entry field, the name of the model and the learning data 1 are read.

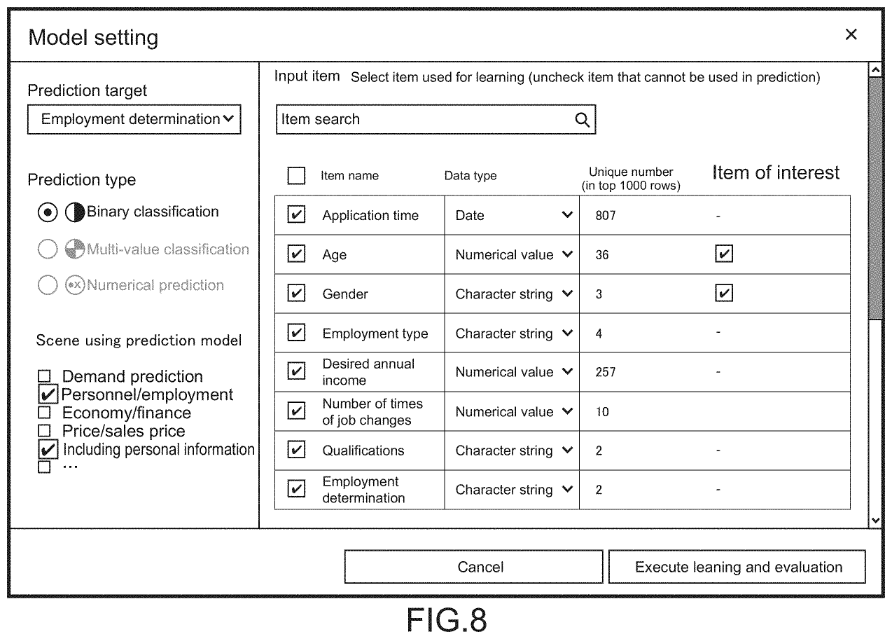

FIG. 8 is an example of a UI screen for inputting various settings relating to the prediction model 10.

Further, the UI screen shown in FIG. 8 is a setting screen for setting the prediction model 10, the setting screen being displayed after the input operation is performed via the start screen. The setting screen is generated on the basis of, for example, items of the learning data 1 specified via the start screen.

As shown in FIG. 8, the setting screen includes a plurality of setting fields.

In the setting field of “prediction target”, a prediction target (target item) of the prediction model 10 can be specified. Here, the “employment determination” in which the item of the “employment result” (see FIG. 3) of the learning data 1 is set as the target item is specified as the prediction target.

In the setting field of “prediction type”, the type of the prediction model 10 can be specified. Here, items of “binary classification”, “multi-value classification”, and “numerical prediction” (regression prediction) are displayed so as to be selectable. In the employment determination, the binary classification is selected as the type of prediction model 10.

In the setting field of “scene using prediction model”, a scene to which the prediction model 10 is applied, and the like can be specified. Here, items such as “demand prediction”, “personnel/employment”, “economy/finance”, “price/sales price”, and “including personal information” are displayed so as to be selectable. In the employment determination, the items of “personnel/employment” and “including personal information” are selected.

In the setting field of “input item”, an item used for learning of the prediction model 10 can be specified from among the items included in the learning data 1. Here, each data item of the learning data 1 shown in FIG. 3 is displayed so as to be selectable. Further, the data type, the unique number, and the like of each data item are displayed.

Further, the setting field of “input item” includes a field for specifying the “item of interest”. The “item of interest” is, for example, an item subjected to restriction by laws and regulations, or a sensitive item that is likely to have an ethical problem.

For example, a data item specified as the “item of interest” is referred to as appropriate when a query for making an inquiry to the rule database 18 is generated or when a check item of the output rule 4 is generated. In the employment determination, the items of “age” and “gender” are selected as the “item of interest”.

Note that the “scene using prediction model” and the “item of interest” do not have to be input.

When the execution button for executing learning and evaluation is pressed after the information necessary for each setting field is input, the learning processing of the prediction model 10 and the like are started.

When the user's input operation via the UI screen is completed, the learning processing for causing the prediction model 10 to perform learning is executed (Step 102).

For example, an appropriate machine learning algorithm is selected in accordance with the type of the prediction model 10 specified in the setting field of “prediction type”, and a learning model is constructed using the algorithm. Subsequently, the training of the learning model using the learning data 1 specified by the user is performed so as to learn the target item specified in the setting column of the “prediction target”. This trained learning model becomes the created prediction model 10.

In this embodiment, the characteristic evaluation unit 22 evaluates the characteristics of the created prediction model 10. The characteristic evaluation may be performed at a timing when the prediction model 10 is generated, or may be performed at a timing when an evaluation screen or the like to be described later is displayed.

FIG. 9 is an example of an evaluation screen for displaying the characteristics of the prediction model 10.

In the evaluation screen shown in FIG. 9, a “prediction accuracy level” indicating the level of prediction accuracy of the created prediction model 10 and a “degree of contribution of items” are displayed.

In the “prediction accuracy level”, for example, the area under the curve (AUC) of the receiver operating characteristic (ROC) curve is displayed as an evaluation index indicating the performance of the prediction model 10. The AUC is an index indicating the classification accuracy of the classification model.

Further, in the “degree of contribution of item”, a bar graph indicating the degree of contribution for each item that has affected the classification is displayed. This makes it possible to compare, for example, items affecting the classification of “to be employed” with items affecting the classification of “not to be employed”.

FIG. 10 shows another example of the evaluation screen for displaying the characteristics of the prediction model 10.

FIG. 10 shows an evaluation screen showing details of the degree of contribution shown in FIG. 9.

On the left side of the evaluation screen, the bar graph similar to that of FIG. 9 is displayed for each item. When the item is selected, the structure of the degree of contribution in the item is displayed on the right side of the evaluation screen.

For example, it is assumed that the item of “age” is selected. In this case, the degree of contribution for each age range is displayed for the classification of “to be employed” (or the classification of “not to be employed”). For example, in FIG. 10, the degree of contribution of the learning data 1 specified by the age from 45 to 50 years old is the highest for the classification of “to be employed”.

In such a manner, the details of the degree of contribution and the like may be analyzed and displayed to the user.

Returning to FIG. 6, when the learning processing of the prediction model 10 is completed, the learning processing for causing the summary model 11 to perform learning is executed (Step 103).

The summary model 11 is caused to perform learning so as to obtain an output close to the prediction model 10 by using the predicted value of the prediction model 10 as correct solution data, for example.

For example, a learning model is constructed using an algorithm such as a decision tree or rule fit. Subsequently, the training of the learning model is executed using the predicted value by the created prediction model 10 as the correct solution data. This trained learning model becomes the created summary model 11.

As a result, as described with reference to C of FIG. 5, a rule group (output rule 4) describing the complicated output of the prediction model 10 in a format that can be interpreted by the user is generated.

When the learning processing of the summary model 11 is completed, the check item 5 relating to the output of the prediction model 10 is displayed (Step 104).

First, an explanatory sentence is generated for each output rule 4 generated by the summary model 11. A check item for checking each output rule 4 is generated using the explanatory sentence.

As an example of the method of creating an explanatory sentence, a rule is created in which the item specified by the user for the “item of interest” is omitted from the set of rules (conditions) constituting the output rule 4. Subsequently, an explanatory sentence is created to explain the output of the rules omitting the “item of interest”.

For example, it is assumed that the output rule 4 of “to be employed if being male and 45 years old or older and having qualifications” is extracted. At that time, if the gender is specified as the “item of interest”, the following explanatory sentence is generated as an explanatory sentence of the output rule: “this is a model for predicting people aged 45 years old or older and having qualifications, in which X % of men and Y % of women should be employed.”

This is an explanatory sentence explaining the output rule 4 for the item of interest (gender) of the user. Using such an explanatory sentence, a check item of the output rule 4 is generated.

As described above, in this embodiment, a check item for a data item (“item of interest”) specified by the user is generated from among a plurality of data items included in the learning data 1 of the prediction model 10.

Note that as described with reference to C of FIG. 5, each output rule 4 corresponds to the conditional area 2 obtained by dividing the distribution of the output of the prediction model 10. Therefore, it can be said that creating the explanatory sentence in such a manner is the processing of outputting an explanation about the distribution of the item of interest (ratio for each gender or the like) in each conditional area 2.

As a result, for example, in the case where attention should be paid to gender, it is possible to allow the user to confirm whether or not this rule violates laws and regulations after the ratio of employment for each gender is explained.

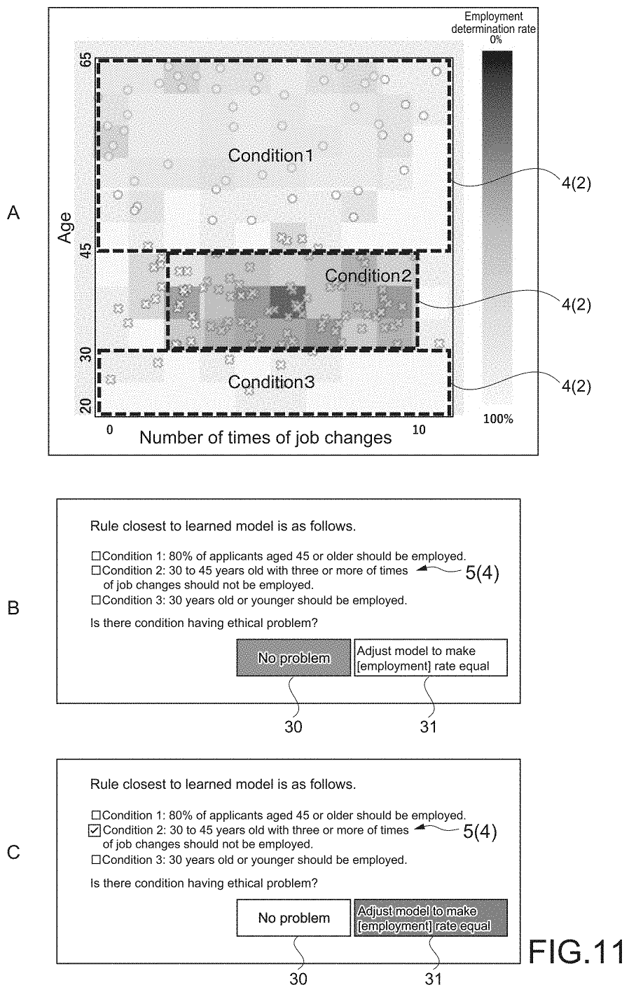

FIG. 11 shows an example of a check screen for the output rule 4.

A of FIG. 11 shows an exemplary display of a map in which a conditional area 2 corresponding to the output rule 4 is drawn. B of FIG. 11 shows an exemplary display of check items 5 relating to the output rule 4. C of FIG. 11 shows an exemplary display when the check item 5 shown in B of FIG. 11 is checked.

For example, the map shown in A of FIG. 11 and the check items 5 shown in B of FIG. 11 are simultaneously displayed on the check screen for the output rule 4. Note that the map in which the conditional area 2 is drawn does not necessarily have to be displayed.

The map shown in A of FIG. 11 is a heat map showing an employment determination rate, which is output by the prediction model 10 that performs an employment determination. The horizontal axis of the map represents the number of times of job changes, and the vertical axis represents age. In this map, as the gray becomes darker, the employment determination rate becomes lower.

Further, in A of FIG. 11, the output rule 4 (conditions 1 to 3 in the drawing) for explaining the output of the prediction model 10 is illustrated as a conditional area 2. Each output rule 4 is described as a condition indicated by a numerical range of the number of times of job changes and a numerical range of the age.

In such a manner, illustrating each output rule 4 (conditions 1 to 3) as a conditional area makes it possible for the user to easily grasp the correspondence relationship between each output rule 4 and the employment determination rate.

In B of FIG. 11, explanatory sentences for the output rule 4, which are described as the conditions 1 to 3, are displayed as check items 5. The condition 1 is the condition that 80% of applicants aged 45 or older should be employed, the condition 2 is the condition that 30 to 45 years old with three or more of times of job changes should not be employed, and the condition 3 is the condition that 30 years old or younger should be employed.

On this screen, an instruction to check whether or not there is an ethical problem with respect to those conditions (output rule 4) is described.

Further, a confirmation button 30 for confirming that there is no problem and an adjustment start button 31 for starting the adjustment of the prediction model 10 are provided below the check items 5. For example, in the absence of a checked condition, the confirmation button 30 is highlighted.

For example, it is assumed that the user determines that the employment rate of the subjects specified in the condition 2 is excessively lowered. In this case, as shown in C of FIG. 11, the checkbox of the condition 2 is checked, and the output rule 4 indicated by the condition 2 is specified as a rule that does not satisfy a predetermined standard, that is, that has an ethical problem. Further, when the check box is checked, the adjustment start button 31 is highlighted.

When the adjustment start button 31 is pressed, for example, the processing of adjusting the prediction model 10 is started such that the employment determination rate becomes equal.

In such a manner, displaying the output rule 4 so as to be interpretable by the user makes it possible to easily confirm an area in which the output of the prediction model 10 violates the ethics, or the like.

Note that the contents displayed on the check screen and the like are not limited. For example, an adjustment value or the like for adjusting the learning parameter of the prediction model 10 may be input.

In the example shown in FIG. 11, the case of determining whether or not each output rule 4 satisfies a predetermined standard has been described. The explanation generation unit 24 can also determine whether or not the output rule 4 satisfies a predetermined standard on the basis of the rule database 18.

Hereinafter, description will be given on the method of creating an explanatory sentence (check item 5) that prompts the user to confirm the laws and regulations in the rule database 18.

For example, it is assumed that information such as laws and regulations necessary for evaluating the prediction model 10 is read from the rule database 18 on the basis of the query generated by the query generation unit 25. In this case, the explanation generation unit 24 compares the output of the prediction model 10 (or the output of the summary model 11) in accordance with the comparison method and the comparison area relating to the rule of the laws and regulations or the like read from the rule database 18.

For example, it is assumed that the rule stipulated by the “Equal Employment Opportunity Act” is output from the rule database 18 as the laws and regulations to evaluate the prediction model 10 that performs an employment determination. In addition, it is assumed that the gender is set as the “item of interest”.

The rule relating to the gender in the Equal Employment Opportunity Act (the rule described in the first column of the table in FIG. 4) describes that the comparison method is “equal” and the comparison area is “all areas” for the gender. The explanation generation unit 24 compares, for example, the employment determination rates for men and women regarding the learning data 1 specified by the output rule 4 to be evaluated. In other words, if the output of the prediction model 10 is divided into the output of the learning data 1 for men and the output of the learning data 1 for women, it is confirmed whether the probabilities of the men and women to be employed are “equal”.

If the probabilities are not equal, it is determined that the target output rule 4 does not satisfy the rule (standard) stipulated by the Equal Employment Opportunity Act, and an explanatory sentence that prompts the user to confirm it is generated.

Specifically, a check item 5 including an explanatory sentence, e.g., “Men are to be employed in X % and women are to be employed in Y % under this condition, which is correct from the viewpoint of the Equal Employment Opportunity Act?”, is generated.

As described above, the explanation generation unit 24 generates, for the output rule 4 determined as failing to satisfy a predetermined standard, a check item 5 that allows the user to check whether or not this output rule 4 satisfies a predetermined standard.

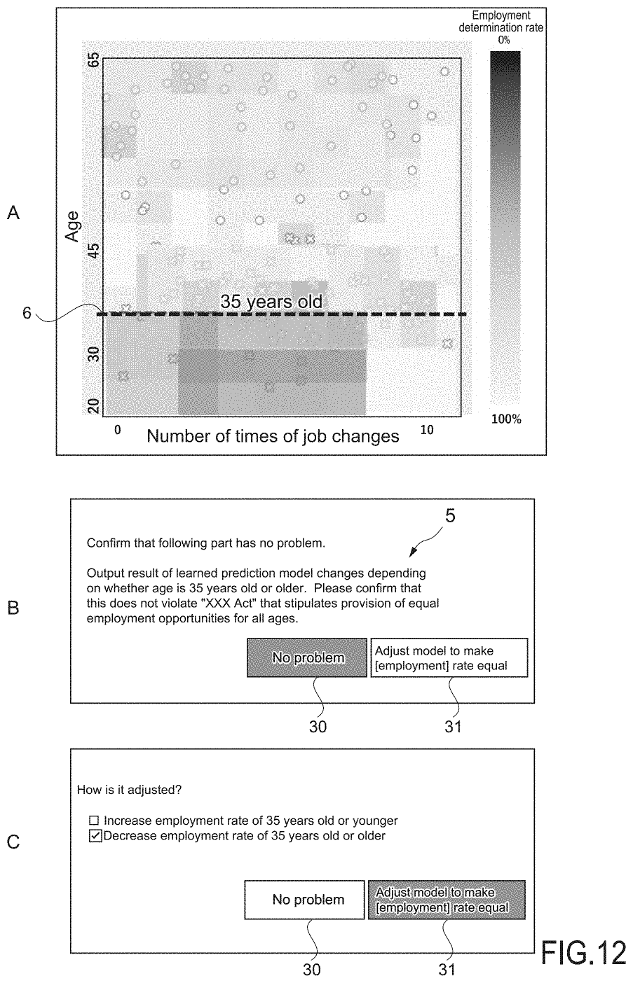

FIG. 12 shows another example of the check screen for the output rule 4. FIG. 12 shows a check screen when the possibility of a legal or ethical problem is automatically detected.

A of FIG. 12 shows an exemplary display of a map in which a borderline 6 corresponding to the output rule 4, which is determined as failing to satisfy a predetermined standard by the explanation generation unit 24, is drawn. B of FIG. 12 shows an exemplary display of a check item 5 relating to the output rule 4. C of FIG. 12 shows an exemplary display of a selection screen for selecting a method of adjusting the prediction model 10.

For example, the map shown in A of FIG. 12 and the check item 5 shown in B of FIG. 12 are simultaneously displayed on the check screen for the output rule 4. Further, the selection screen shown in C of FIG. 12 is displayed when the user selects the adjustment of the prediction model 10.

For example, since the prediction model 10 that performs an employment determination is used in the task of the human resources, the item of the personnel/employment is checked as the “scene using prediction model” from the setting screen shown in FIG. 8. As a result, the laws and regulations in the field of personnel/employment in the rule database 18 are confirmed, and it is determined whether or not the output of the prediction model 10 satisfies the standard specified by the laws and regulations.

The check screen shown in FIG. 12 is a screen for prompting the user to confirm that the employment determination rate shows an unnatural biased distribution at the age of 35. A of FIG. 12 shows the borderline 6 at which the employment determination rate changes. The borderline 6 can be detected, for example, as a border of the conditional area 2 indicating the output rule 4.

B of FIG. 12 displays an explanatory sentence relating to the borderline 6 as a check item 5. This explanatory sentence describes the characteristics of the prediction model 10 that the output result of the prediction model 10 changes depending on whether or not the age is 35 years old or older. The explanatory sentence also includes an explanation to prompt the user to confirm whether or not such characteristics do not violate the XXX Act (laws and regulations in the field of personnel/employment), which stipulates provision of equal employment opportunities for all ages.

Below the explanatory sentence, a confirmation button 30 for confirming that there is no problem and an adjustment start button 31 for starting the adjustment of the prediction model 10 are provided.

For example, it is assumed that the user confirms the “XXX Act” for the characteristics of the prediction model 10 and determines that the characteristics violate the XXX Act. In this case, when the adjustment start button 31 is pressed, the processing of adjusting the prediction model 10 is started such that the employment determination rate becomes equal regardless of the age.

As described above, determining the output (output rule 4) of the prediction model 10 on the basis of the rule database 18 makes it possible to point out, for example, a problem that is not noticed by the user.

When the adjustment start button 31 is selected, a selection screen as shown in C of FIG. 12 is displayed. On the selection screen, an adjustment method of increasing the employment rate of 35 years old or younger and an adjustment method of decreasing the employment rate of 35 years old or older are displayed so as to be selectable as the method of uniformly adjusting the employment determination rate.

Further, a confirmation button 30 for confirming that there is no problem, and an adjustment start button 31 for starting the adjustment of the prediction model 10 are provided on the lower side of the adjustment method.

For example, using the adjustment method of decreasing the employment rate of 35 years old or older makes it possible to adjust the overall employment determination rate to be lower. Conversely, using the adjustment method of increasing the employment rate of 35 years old or younger makes it possible to adjust the overall employment determination rate to be higher.

The user can start the adjustment processing using the selected adjustment method by checking the check box of one of the adjustment methods and selecting the adjustment start button.

As described above, in this embodiment, a plurality of adjustment methods relating to the output of the prediction model 10 is presented in a selectable manner. The learning processing of the prediction model 10 is then adjusted on the basis of the method selected by the user among the plurality of adjustment methods.

This makes it possible to perform adjustment in accordance with the situation to which the prediction model 10 is applied, or the like.

Returning to FIG. 6, when the user's input operation via the check screen is completed, the check result of the check item 5 is read (Step 105). Subsequently, it is determined on the basis of the check result whether or not there is an area (data range) that does not satisfy a predetermined standard, that is, there is a violation rule, in the output of the prediction model 10 (Step 106).

For example, if any one of the check items 5 (conditions 1 to 3) shown in B of FIG. 11 is checked, or if the adjustment start button 31 shown in B of FIG. 12 is selected, it is determined that there is an area that does not satisfy a predetermined standard (Yes in Step 106).

Further, for example, if all the check items 5 are not checked, it is determined that all the areas of the output of the prediction model 10 do not violate the laws and regulations, and that there is no area that does not satisfy a predetermined standard (No in Step 106), and the processing of creating the prediction model 10 is completed.

If there is an area that does not satisfy a predetermined standard, the adjustment processing unit 26 extracts the learning data 1 corresponding to such an area (Step 107). Specifically, information for specifying the learning data 1 (ID of the learning data 1, etc.) that matches the output rule 4 (violation rule), which is checked by the user when the user determines that it violates the laws and regulations and the like, is extracted.

For example, if it is determined that the rule (condition 2 shown in B of FIG. 11), in which the number of times of job changes is three or more and the age is 30 to 45 years old, is a violation rule, the ID of the learning data 1 that satisfies this condition is read.

If the learning data 1 that matches the violation rule is extracted, the adjustment processing unit 26 generates an instruction to adjust the prediction model 10 (Step 108).

First, the predicted value that violates the rule (the output of the prediction model 10 in the learning data 1 that matches the violation rule) is compared with the predicted value that does not violate the rule to calculate an adjustment policy indicating how the predicted value that violates the rule is changed so as not to violate the rule.

If the classification model is used as the prediction model 10, the learning processing of the prediction model 10 is adjusted such that the predicted value of the prediction model 10 in the area specified by the violation rule substantially matches the predicted value of the prediction model 10 in the area specified by the output rule 4 satisfying a predetermined standard.

For example, for the prediction model 10 that predicts the classification of “employ/not employ”, the ratio in which “employ” is predicted (predicted value) is calculated for each of the area that violates the rule and the area that does not violate the rule. Subsequently, the following policy is selected: the ratio in which “employ” is predicted in the area that violates the rule is adjusted to the ratio in which “employ” is predicted in the area that does not violate the rule.

At that time, the degree of adjustment of the prediction model 10 (adjustment amount, etc.) is calculated such that the ratio in which “employ” is predicted substantially matches the ratio in each area.

Next, an adjustment instruction for the prediction model 10 is generated in accordance with a policy and an adjustment amount to prevent violation of the rule. Specifically, an adjustment instruction corresponding to an adjustment method of adjusting the learning processing of the prediction model 10 is generated. The adjustment method for the prediction model 10 (classification model) includes a plurality of methods.

As the adjustment method for the prediction model 10, a method of adjusting a weight coefficient of the learning data 1 may be used.

For example, the weight coefficient of the learning data 1 included in the area specified by the violation rule is increased, the violation rule having a high ratio in which “not employ” is predicted.

Hence, the area specified by the violation rule obtains a high ratio in which “employ” is predicted, with the result that its predicted value can substantially coincide with that of the area specified by the output rule 4 other than the violation rule. Such a weight coefficient is generated as an adjustment instruction.

In this embodiment, the weight coefficient is an example of a parameter for adjusting the output of the prediction model relating to the learning data.

In addition, for example, as the adjustment method for the prediction model 10, a method of adjusting a determination threshold at the time of determining a prediction may be used.

For example, the probability of “employ” is calculated for each of the learning data 1 included in the area specified by the violation rule, the violation rule having a high ratio in which “employ” is predicted, and the determination threshold for determining “employ” is made higher than that for other areas. For example, in the area specified by the output rule 4 other than the violation rule, when the prediction model 10 outputs “should be employed with a 50% probability”, “employ” is determined. On the other hand, in the area specified by the violation rule, the determination threshold is set high, and only when “should be employed with a probability of 80% or more” is output, “employ” is determined.

This makes it possible to reduce the ratio in which “employ” is predicted for the violation rule, and consequently makes it possible to bring the above ratio close to the ratio in which “employ” is predicted for the other output rule 4. Such a determination coefficient is generated as an adjustment instruction.

In this embodiment, the determination threshold is an example of a parameter for adjusting the output of the prediction model relating to the learning data.

Further, for example, a method of thinning out the learning data 1 may be used as the adjustment method for the prediction model 10.

For example, for a violation rule having a high ratio in which “employ” is predicted, the learning data 1 labeled with “employ” in the area specified by the violation rule is thinned out, and the learning processing is performed using the learning data 1 in which the number of pieces of data has been reduced. Therefore, this adjustment method can be said to be the processing of reducing the number of pieces of learning data, which causes a violation rule failing to satisfy a predetermined standard, among the pieces of learning data 1 included in the area specified by the violation rule.

This makes it possible to reduce the ratio in which “employ” is predicted for the violation rule, and consequently makes it possible to bring the above ratio close to the ratio in which “employ” is predicted for the other output rule 4. In this case, the ID or the like of the learning data 1 to be thinned out is generated as the adjustment instruction.

As described above, in this embodiment, at least one of the learning data 1 of the prediction model 10 or the learning parameter of the prediction model 10 is adjusted on the basis of the area (data range) specified by the violation rule. This makes it possible to appropriately adjust the output of the prediction model 10 in which an ethical violation or the like has occurred.

When the adjustment instruction is generated, Step 101 is executed again, and the prediction model learning unit 21 starts the learning processing of re-creating the prediction model 10 so as to reduce predictions that violate the rule. Repeating such processing makes it possible to finally construct the prediction model 10 that does not violate the laws and regulations.

[Adjustment Method for Regression Model]

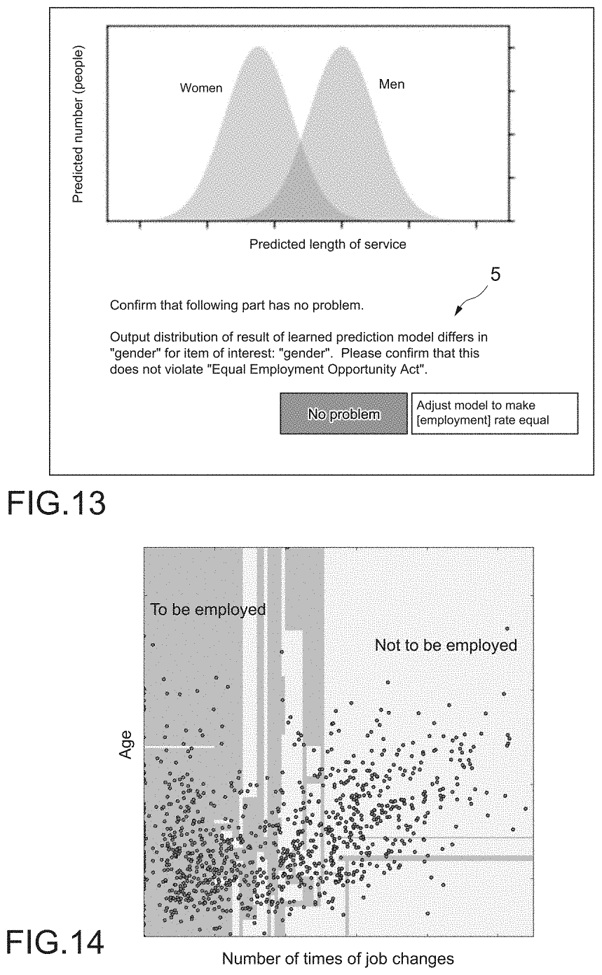

FIG. 13 is an example of a check screen displayed when a regression model is used. Here, description will be given on processing when a regression model for predicting an item value of a target item is used as the prediction model 10.

The summary model 11, which has summarized a regression model, generates an output rule 4 that divides a map of predicted values, for example, the output of the prediction model 10, into a plurality of areas (data ranges). In the data analysis apparatus 100, it is evaluated whether or not the distribution of the predicted values satisfies the laws and regulations and the like for each area specified by the output rule 4.

FIG. 13 shows a check screen for the prediction model 10 that predicts the expected length of service of subjects. The graph in the upper part of the figure is a histogram of the predicted length of service for each gender. The horizontal axis of the graph represents the predicted length of service, and the vertical axis represents the number of subjects whose length of service is predicted. In this histogram, the center of the distribution of the length of service of men is higher than the center of the distribution of the length of service of women.

The explanatory sentence shown in the lower part of the figure is a check item for prompting the user to confirm the distribution of the predicted values of the length of service.

In the case of performing the prediction of the length of service, for example, the output of the learning data 1 for men and the output of the learning data 1 for women are separately calculated in the output of the prediction model 10. Subsequently, it is confirmed whether or not the expected length of service is “equal” between men and women.

Since the length of service is expressed as a numerical value, it cannot be described as a probability. In this case, as shown in FIG. 13, the distributions (histograms) of the predicted length of service of men and women are calculated and compared using parameters for comparing the distributions (e.g., Histogram Intersection, KL divergence, JS divergence, etc.).

For example, if the difference in the distributions between men and women exceeds a certain threshold, the area (output rule 4) in which such distributions are calculated is highly likely to be a violation rule that is ethically problematic. For this reason, the data analysis apparatus 100 outputs a check item 5, for example, “There is a discrepancy between the outputs of the predicted values for men and women. Is it problematic?”

Note that in the area specified by the output rule 4 other than the violation rule, that is, an area where there is no violation, a prediction result in which the distributions of men and women substantially coincide with each other is obtained, for example.

In the example shown in FIG. 13, the explanatory sentence (check item 5) is displayed, which prompt the user to confirm that the output distributions are different for “gender” and confirm whether or not the result violates the “Equal Employment Opportunity Act”.

If the user determines that there is a problem of the difference in the distributions, the adjustment of the prediction model 10 is started by selection of the adjustment start button 31.

If the regression model is used as the prediction model 10, the learning processing of the prediction model 10 is adjusted such that the distribution of the predicted values of the prediction model 10 in the area specified by the violation rule substantially coincides with the distribution of the predicted values of the prediction model 10 in the area specified by the output rule 4 that satisfies a predetermined standard.

For example, for the prediction model 10 that predicts the “length of service”, adjustment is performed such that the shape of the distribution of the predicted “length of service” becomes equal for each of the area in which the rule is violated and the area in which the rule is not violated. For example, a comparison parameter, such as a KL divergence (Kullback-Leibler distance), relating to the length of service between the area in which the rule is violated and the area in which the rule is not violated, is calculated. The degree to which the prediction model 10 is adjusted (e.g., the adjustment amount) is calculated such that the comparison parameter becomes small.

Next, an adjustment instruction for the prediction model 10 is generated in accordance with the calculated adjustment amount. Specifically, an adjustment instruction corresponding to an adjustment method of adjusting the learning processing of the prediction model 10 is appropriately generated. The adjustment method for the prediction model 10 (regression model) includes a plurality of methods.

As the adjustment method for the prediction model 10, a method of adjusting a parameter for adjusting the loss function of the prediction model 10 may be used.

In general, the prediction model 10 performs learning to decrease the value of the loss function. Therefore, for example, for the area specified by the violation rule, a penalty is set to increase the loss function if a predicted value that violates a rule is predicted. Consequently, this makes it possible to lower the ratio in which the predicted value that violates the rule is predicted.

For example, for a violation rule in which the length of service is predicted to be excessively long, quantile regression is set for the loss function used for training of the prediction model 10 only in that area, and the loss function is shifted. At that time, the penalty is increased when the length of service is predicted to be longer in the area in which the rule is violated, so that it is possible to make the prediction in the area in which the rule is violated close to that in the area in which the rule is not violated. A parameter for adjusting such a loss function is generated as the adjustment instruction.

Further, for example, a method of thinning out the learning data 1 may be used as the adjustment method for the prediction model 10. Specifically, the learning data 1 that causes the violation rule failing to satisfy the predetermined standard is thinned out from the learning data 1 included in the area specified by the violation rule.

For example, for a violation rule having a high ratio in which the length of service is predicted to be longer, the learning data 1 is thinned out in the order of the longer length of service in the area specified by the violation rule, and the learning processing is performed using the learning data 1 in which the number of pieces of data has been reduced. In this case, the ID or the like of the learning data 1 to be thinned out is generated as the adjustment instruction.

This makes it possible to reduce the ratio in which the length of service is predicted to be longer in the area specified by the violation rule.

Further, for example, a method of adding dummy learning data 1 (dummy data) that does not exist originally may be used as the adjustment method for the prediction model 10.

For example, for a violation rule in which the predicted length of service of men is excessively long, data in which the length of service of men is short is generated and used for training of the prediction model 10. Therefore, this adjustment method can be said to be the processing of adding the dummy data adjusted to satisfy the predetermined standard, as the learning data 1, to the area specified by the violation rule.

As a result, it is possible to shorten the length of service predicted in the violation rule and consequently to approximate the distribution of the length of service predicted in another output rule 4. In this case, along with the dummy data information, an instruction to add the dummy data to the learning data 1 is generated as the adjustment instruction.

As described above, even if the regression model is used as the prediction model 10, it is possible to easily adjust the output determined as having a problem of ethical violation or fairness, and to solve the problem.

Note that the above adjustment method in the classification model may be applied to the adjustment method in the regression model, or conversely, the adjustment method in the regression model may be applied to the adjustment method in the classification model. Further, each adjustment method may be used alone, or the plurality of adjustment methods may be used in combination. Further, the parameters (weight coefficient etc.) used for each adjustment may be calculated in accordance with the contents of the violation or the like, or may be input by the user. In addition, the adjustment method for the prediction model 10 is not limited, and any adjustment method capable of solving the contents of the violation may be used, for example.

Hereinafter, the flow to the construction of the prediction model 10 will be specifically described for each application example of the data analysis apparatus 100.

### Application Example 1

Example in which a person in charge of human resources (user) creates a prediction model 10 for predicting whether to employ or not on the basis of “gender”, “age”, “acquired qualifications”, and “number of times of job changes”.

First, the start screen, the setting screen, and the like are displayed, and learning data 1 to be used, target items, and the like are specified by the user.

A learning model (e.g., a neural network) is trained on the basis of the specified learning data 1 and the like, and a prediction model 10 is created.

An algorithm for summarizing the prediction model 10 (e.g., a rule fit for creating a model obtained by combining a plurality of rules) is used to create a summary model 11, and the output of the prediction model 10 is summarized as a combination of a plurality of output rules 4.

Here, it is assumed that an output rule 4 of “should be employed if the age is 50 to 60 years” is created from the summary model 11. At that time, for the gender set as the item of interest, the ratio predicted to be employed for each gender is calculated.

For example, in the output rule 4 described above, if the ratio of employing men is higher than the ratio of employing women, the check item 5 is generated and displayed on the check screen together with an explanatory sentence such as “in the age is 50 to 60 years, the number of men to be employed is excessively large, which is problematic?” Note that an explanatory sentence that simply explains the ratio to “employ” men and women may also be used.

If the user looks at the check item 5 and determines that the output rule 4 is ethically violated, the check item 5 is checked and the output rule 4 becomes a violation rule.

In the adjustment processing of the prediction model 10, the weighting (weight coefficient) of the learning data 1 corresponding to the violation rule (the data corresponding to men in the age range of 50 to 60 years old) is set to be light, and the learning processing of the prediction model 10 is executed again. This makes it possible to lower the ratio in which men of 50 to 60 years old are determined to be “employed”.

If the re-learning of the prediction model 10 is completed, a plurality of output rules 4 approximating the re-trained prediction model 10 using the summary model 11 is generated, and each output rule 4 is displayed as a check item 5 together with an explanatory sentence.

If the user confirms that all the output rules 4 have no ethical problems, the latest prediction model 10 at that time is determined as a model to be used for future prediction.

### Application Example 2

Example in which a person in charge of human resources (user) creates a prediction model 10 for predicting whether to employ or not on the basis of “gender”, “age”, “acquired qualifications”, and “number of times job changes”, and confirms whether or not the prediction model 10 does not violate laws and regulations and the like.

First, a prediction model 10 and a summary model 11 are generated as in Application Example 1.

It is assumed that an output rule 4 of “should not be employed if the age is 75 to 90 years and the acquired qualification includes an automobile license” is created from the summary model 11. Further, it is assumed that the user determines that there is no ethical problem with respect to the output rule 4.

In this case, the output rule 4 is read as an output rule 4 that is not a violation rule.

At that time, the data analysis apparatus 100 generates the following query and makes an inquiry to the rule database 18.

Query: (Field=Human Resources, Problem Setting=Classification, Items of Interest=Age)

As a result, a condition A is referred to as a rule corresponding to the inquiry condition. The condition A is specified as follows: (the item of comparison method=equal, and the comparison area=all). This means that the fields covered by the prediction model 10 should be treated equally regardless of age.

In this case, the data of the age of 65 or older should be treated equally on the basis of the database, but an unnatural distribution is found only in the ages of 75 and 90. The user is notified of a possibility that the output rule 4 may violate a regulation A. For example, a check item 5 or the like is generated to prompt the user to confirm whether “the area in the ages of 75 and 90 does not violate the regulation A?”

As described above, in the data analysis apparatus 100, it is possible to automatically determine an ethical problem, an output lacking fairness, or the like and to alert the user. As a result, it is possible to surely confirm a rule violation or the like that the user has overlooked, and it is possible to easily construct a highly reliable prediction model 10.

### Application Example 3

Example of creating a prediction model 10 for determining a ticket price when performing dynamic pricing of a ticket to watch a sports game.

Here, description will be given on a method of adjusting the prediction model 10 for handling a regression problem (regression model), which predicts in real time an appropriate selling price of a ticket to watch a sports game whose price varies.

First, learning data 1 to be used, a target item (selling price), and the like are specified by the user. The learning data 1 is, for example, personal data such as the gender and age of a customer who purchases the ticket, and data relating to the ticket such as the history of the tickets purchased by the customer in the past, the game time of the ticket to be purchased, and an opponent team.

From such learning data 1, a prediction model 10 that predicts the price at which the customer will buy a ticket, i.e., predicts the price at which the customer is expected to buy a ticket, is created.

For example, an opponent team is specified as the “item of interest”. The creation of the prediction model 10 is started, and the prediction model 10 and the summary model 11 are generated in a manner similar to that in the Application Example 1.

Specifying the opponent team as the “item of interest” makes it possible to perform an adjustment to suppress the difference in ticket price between the opponent teams, that is, the variation in ticket price corresponding to the opponent teams or the like.

For example, it is assumed that an output rule 4 of “ticket price (yen) of tickets after 18:00 p.m.=5000−(number of people accommodated in the game site)+(correction based on personal data)” is obtained from the summary model 11.

As described above, since the team name is specified as the “item of interest”, the distributions of “tickets after 18 p.m.” for a team A and a team B are compared here. Specifically, a histogram of prices is created for each team, and the distance between the distributions is compared using the KL divergence or the like.

As a result, it is assumed that there is a large difference in the distribution of the estimated selling price of the ticket between the case where the opponent team is the team A and the case where the opponent team is the team B. In this case, an alert (check item 5 or the like) indicating that the selling price varies between the team A and the team B is output.

When the alert is displayed, the user confirms the distribution of the ticket price for each team. For example, when the user determines that the distribution of the ticket price lacks fairness, the adjustment start button 31 for correcting the deviation of the distribution is selected.

For example, suppose that the price is predicted to be excessively high when the team B is the opponent team. In this case, if an excessively high price is predicted for the ticket price of the team B in the tickets after 18:00 p.m., the loss function used for the training of the prediction model 10 is adjusted to increase the loss.

The adjusted loss function is used to create the prediction model 10 again. If the distribution of the output of the newly created prediction model 10 is displayed and it is confirmed that there is no problem, the creation of the prediction model 10 is completed.

In such a manner, in the prediction model 10 for solving the regression problem, it is possible to cause the user to check a rule whose predicted value becomes excessively large (or small). This makes it possible to easily construct the prediction model 10 that performs fair price prediction.

As described above, in the control unit 16 according to this embodiment, the learning processing is performed between a predetermined learning model (the prediction model 10 and an authentication model) and the summary model 11 that converts the output thereof. The summary model 11 converts the output of the prediction model 10 into a rules group described in a format that can be interpreted by a user. The learning processing of the learning model is adjusted by using the evaluation information obtained by evaluating the rule group in accordance with a predetermined standard. This makes it possible to easily construct a learning model that satisfies necessary standards.

In recent years, a prediction model whose outputs have ethical problems due to a deviation of past data or a method of taking data has become a problem in the prediction analysis. For example, it is assumed that a model for predicting how many years applicants can continue working is used at the time of employment. In this case, an excessively long length of service may be predicted for only men because many male employees have been worked in the past. The creator of the prediction model may be unaware of such a problem. Even if the creator notices the problem, it is often difficult to solve the problem.

FIG. 14 is a map of the output of the prediction model given as a comparative example. The horizontal axis of the map represents the number of times of job changes, and the vertical axis represents the age. Further, the gray area of the map is an area predicted as “employ” by the prediction model, and the white area is an area predicted as “not employ” by the prediction model. Each data point corresponds to the individual learning data. As shown in FIG. 14, the output of the prediction model (distribution of “employ” and “not employ”) is complicated.

For this reason, for example, it is difficult to confirm whether or not there is a case of violating ethics or the like under a specific condition. Further, even an expert (of a neural net or the like) may have difficulty in confirming a detailed case depending on a prediction model.

Further, if the creator of the model is not an expert, the creator has difficulty in adjusting the prediction model to correct the problem, because the creator does not know the method of adjusting the parameters of the prediction model or the like.

In addition, it is necessary to prepare all the rules that must not be violated (laws and regulations and the like that must be observed) in advance, and there has been a possibility that it takes time to check violations and that oversight occurs.

In this embodiment, the summary model 11 for replacing the prediction model 10 with a set of decision trees and rules that can be understood by a human being is used. This makes it possible to display an explanation of the output rule 4 that can be interpreted by the user, e.g., “If it applies to A and B, a deviation is found in men.”

This makes it possible for the user to easily understand the output of the prediction model. As a result, for example, even a user who does not understand the algorithm of the prediction model 10 can confirm whether or not there is a problem in the output of the prediction model.

The explanatory sentence of the output rule 4 is displayed as a check item for the user to check whether or not the rule/ethics is violated. The prediction model 10 is adjusted on the basis of the contents checked in the check item 5.

For example, the data matching the output rule 4 (violation rule) that the user has pointed out as having a problem is compared with the data matching the output rule 4 having no problem. Subsequently, in accordance with the comparison result, the data matching the violation rule is automatically adjusted so as to be close to the prediction or the like of another output rule 4. Alternatively, the learning parameters for each data are adjusted accordingly.

As described above, in this embodiment, it is possible to easily correct the output for the area or the like having an ethical problem in the output of the prediction model 10 through the summary model 11.

Further, in this embodiment, a set of laws and rules to be observed for each use scene of the prediction model 10 is stored in advance as the rule database 18. Subsequently, a query for inquiring the location of the decision border between the prediction model 10 and the summary model 11 from rule database 18 is generated, and the necessary standards (rules) are read as appropriate. This makes it possible to automatically check for ethical problems. As a result, it is possible to shorten the time required for checking the violation and to sufficiently avoid occurrence of overlooking by the user. This makes it possible to easily construct a learning model that satisfies necessary standards.

### Other Embodiments

The present technology is not limited to the embodiment described above and can implement various other embodiments.

In the above embodiment, the method of adjusting the prediction model has been mainly described. The present technology is not limited to the prediction model and can be applied to any learning model.

Hereinafter, a case of correcting an error rate of an authentication system using a camera will be described as an application example. Here, an authentication model trained using image data generated with a camera as learning data will be exemplified. The authentication model is an example of a predetermined learning model.

Note that, in the authentication model, image data is used as learning data instead of the learning data in a tabular format such as CSV.

It is assumed that an authentication model for performing person authentication or the like is generated by using a camera installed in a gate of a company. In the following, it is assumed that an authentication model for authenticating only a person who wears a company uniform is created.

First, image data of various persons wearing company uniforms is prepared as data of persons to be authenticated, and image data of various persons wearing private clothes is prepared as data of persons not to be authenticated. These pieces of image data are used as learning data to cause the authentication model to perform learning.

A summary model that summarizes the authentication model includes, for example, a random forest model using bag of features (BoF). Here, BoF is a method of creating a model with a fragment of an element included in an image as a feature amount. By clustering the feature amounts extracted from a plurality of images, an index called visual words (VW) is generated. For example, matching the feature amount extracted from a target image with the VW makes it possible to perform person authentication or the like.

Further, the random forest is, for example, a learning model in which algorithms of decision trees are randomly combined.

For the summary model, a model representing whether or not the VW created by the BoF exists in an image using 0 or 1 vector is created and then input to a random forest, thereby creating a model classifying whether or not the uniform is worn. In this case, it is possible to summarize the authentication model as a set of conditions on whether each VW is included or not included.

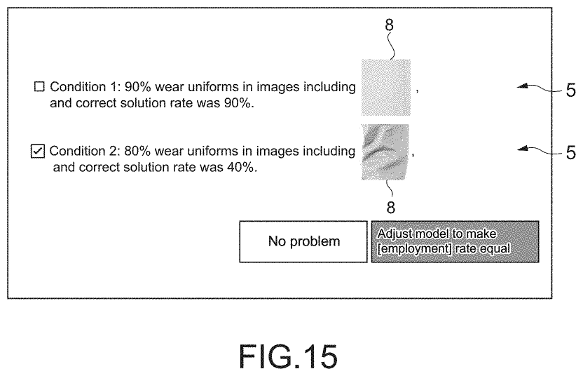

FIG. 15 shows an example of a check screen displayed when the authentication model is used.

Use of the summary model described above makes it possible to calculate the degree of importance (contribution) of each feature in the authentication. As a result, it is possible to detect the VW, which is important in making the prediction.

FIG. 15 displays check items 5 (conditions 1 and 2) indicating the correct solution rate of the authentication for each image feature 8 (VW) contributing to the prediction in the image data including the image features 8. Those check items 5 are examples of output rules for describing the output of the authentication model.

For example, in the condition 1, it is explained that 90% wear the uniforms in the images including the image feature 8 of the clothes with less wrinkles, and the correct solution rate of the authentication is 90%. Further, in the condition 2, it is explained that 80% wear the uniforms in the images including the image feature 8 of the clothes with many wrinkles, and the correct solution rate of the authentication is 40%.

From above, it can be understood that if the image feature 8 created on the basis of the “uniform with many wrinkles” exists, the probability of authentication decreases.

In this case, the learning data in which a feature close to “uniform with many wrinkles” exists in the image feature created using the BoF is extracted from a plurality of pieces of learning data. As the adjustment of the authentication model, an adjustment is performed to increase the parameter update range, that is, perform classification more carefully than other learning data only when learning is performed using the extracted learning data.

After the adjusted authentication model and the summary model thereof are created, an explanatory sentence for explaining the summary result and the like are displayed. Here, when the user determines that the classification accuracy for the persons wearing the uniforms with many wrinkles is improved, the creation of the authentication model is completed.

This makes it possible to easily construct an authentication model with high detection accuracy.

In the above embodiment, the learning processing of the prediction model is adjusted by mainly using the user's check result of the check item as the evaluation information. The present technology is not limited to the above, and for example, the learning processing of the prediction model may be adjusted using the evaluation information automatically generated by the explanation generation unit.

Specifically, the explanation generation unit may generate, as the evaluation information, information relating to an output rule determined as failing to satisfy a predetermined standard. In this case, for example, the output rule that is determined as violating the laws and regulations and the like is set as the violation rule by referring to the rule database, and the prediction model is automatically adjusted. This makes it possible to automatically construct a prediction model that does not violate the laws and regulations and the like.

In the above description, the single control unit 16 has been exemplified as one embodiment of the information processing apparatus according to the present technology. However, the information processing apparatus according to the present technology may be provided by an arbitrary computer that is configured separately from the control unit 16 and connected to the control unit 16 via wire or wirelessly. For example, the information processing method according to the present technology may be executed a cloud server. Alternatively, the information processing method according to the present technology may be performed by the control unit 16 and another computer operating cooperatively.

In other words, the information processing method and the program according to the present technology can be performed not only in a computer system formed of a single computer, but also in a computer system in which a plurality of computers operates cooperatively. Note that, in the present disclosure, the system refers to a set of components (such as apparatuses and modules (parts)) and it does not matter whether all of the components are in a single housing. Thus, a plurality of apparatuses accommodated in separate housings and connected to each other through a network, and a single apparatus in which a plurality of modules is accommodated in a single housing are both the system.

The execution of the information processing method and the program according to the present technology by the computer system includes, for example, both a case in which processing of causing a predetermined learning model to perform learning, processing of causing a summary model to perform learning, acquisition of evaluation information, adjustment of the learning processing of the learning model, and the like are performed by a single computer; and a case in which processing are executed by different computers. Further, the execution of each processing by a predetermined computer includes causing another computer to perform a portion of or all of the processing and obtaining a result thereof.

In other words, the information processing method and the program according to the present technology are also applicable to a configuration of cloud computing in which a single function is shared and cooperatively processed by a plurality of apparatuses through a network.

Of the feature portions according to the present technology described above, at least two feature portions can be combined. In other words, the various feature portions described in the embodiments may be arbitrarily combined without distinguishing between the embodiments. Further, the various effects described above are not limitative but are merely illustrative, and other effects may be provided.

In the present disclosure, “same”, “equal”, “orthogonal”, and the like are concepts including “substantially the same”, “substantially equal”, “substantially orthogonal”, and the like. For example, the states included in a predetermined range (e.g., range of ±10%) with reference to “completely the same”, “completely equal”, “completely orthogonal”, and the like are also included.

Note that the present technology may also take the following configurations.

(1) An information processing apparatus, including:

a first learning unit that causes a predetermined learning model to perform learning;

a second learning unit that causes a conversion model to perform learning, the conversion model converting an output of the predetermined learning model into a rule group described in a format that can be interpreted by a user;

an evaluation unit that acquires evaluation information obtained by evaluating the rule group in accordance with a predetermined standard; and

an adjustment unit that adjusts learning processing of the predetermined learning model on the basis of the evaluation information.

(2) The information processing apparatus according to (1), in which

the predetermined standard includes at least one of a standard defined by law or a standard defined by the user.

(3) The information processing apparatus according to (1) or (2), in which

the learning model is a prediction model for predicting a target item.

(4) The information processing apparatus according to (3), in which

the rule group includes at least one output rule describing an output of the prediction model, and

the evaluation unit generates at least one of an explanatory sentence or a chart relating to each of the output rules.

(5) The information processing apparatus according to (4), in which

the evaluation unit generates a check item for causing the user to check whether or not each of the output rules satisfies the predetermined standard.

(6) The information processing apparatus according to (5), in which

the evaluation unit reads, as the evaluation information, a check result of the check item by the user.

(7) The information processing apparatus according to (4) or (5), in which

the evaluation unit generates the check item of a data item specified by the user among a plurality of data items included in learning data of the prediction model.

(8) The information processing apparatus according to any one of (4) to (7), further including

a storage unit that stores a database relating to the predetermined standard, in which

the evaluation unit determines whether or not the output rule satisfies the predetermined standard on the basis of the database.

(9) The information processing apparatus according to (8), in which

the evaluation unit generates a check item for the output rule determined as failing to satisfy the predetermined standard, the check item causing the user to check whether or not the output rule satisfies the predetermined standard.

(10) The information processing apparatus according to (8) or (9), in which

the evaluation unit generates, as the evaluation information, information relating to the output rule determined as failing to satisfy the predetermined standard.

(11) The information processing apparatus according to any one of (4) to (10), in which

the evaluation information includes information relating to a violation rule that is the output rule failing to satisfy the predetermined standard, and

the adjustment unit adjusts at least one of learning data of the prediction model or a learning parameter of the prediction model with reference to a data range specified by the violation rule.

(12) The information processing apparatus according to (11), in which

the adjustment unit performs at least one of processing to reduce the number of pieces of the learning data that causes the violation rule failing to satisfy the predetermined standard, in the learning data included in the data range specified by the violation rule, or processing to add dummy data as the learning data to the data range specified by the violation rule, the dummy data being adjusted to satisfy the predetermined standard.

(13) The information processing apparatus according to (11) or (12), in which

the learning parameter includes at least one of a parameter for adjusting the output of the prediction model relating to the learning data or a parameter for adjusting a loss function of the prediction model.

(14) The information processing apparatus according to any one of (11) to (13), in which

the prediction model is a classification model using a classification relating to the target item as a predicted value, and

the adjustment unit adjusts learning processing of the prediction model such that the predicted value of the prediction model in the data range specified by the violation rule substantially matches the predicted value of the prediction model in a data range specified by the output rule that satisfies the predetermined standard.

(15) The information processing apparatus according to any one of (11) to (13), in which

the prediction model is a regression model using a value of the target item as a predicted value, and

the adjustment unit adjusts learning processing of the prediction model such that a distribution of the predicted value of the prediction model in the data range specified by the violation rule substantially matches a distribution of the predicted value of the prediction model in a data range specified by the output rule that satisfies the predetermined standard.

(16) The information processing apparatus according to any one of (3) to (15), in which

the evaluation unit presents a plurality of adjustment methods relating to an output of the prediction model in a selectable manner, and

the adjustment unit adjusts learning processing of the prediction model on the basis of a method selected by the user among the plurality of adjustment methods.

(17) The information processing apparatus according to any one of (1) to (16), in which

the second learning unit causes the conversion model to perform learning, the conversion model conforming to the predetermined standard.

(18) The information processing apparatus according to any one of (1) to (17), in which

the conversion model is a learning model using at least one algorithm of a decision tree or a rule fit.

(19) An information processing method, including:

causing a predetermined learning model to perform learning;

causing a conversion model to perform learning, the conversion model converting an output of the predetermined learning model into a rule group described in a format that can be interpreted by a user;

acquiring evaluation information obtained by evaluating the rule group in accordance with a predetermined standard; and

adjusting learning processing of the predetermined learning model on the basis of the evaluation information,

which are executed by a computer system.

(20) A program, which causes a computer system to execute the steps of:

causing a predetermined learning model to perform learning;

causing a conversion model to perform learning, the conversion model converting an output of the predetermined learning model into a rule group described in a format that can be interpreted by a user;

acquiring evaluation information obtained by evaluating the rule group in accordance with a predetermined standard; and

adjusting learning processing of the predetermined learning model on the basis of the evaluation information.

### REFERENCE SIGNS LIST

1 learning data
2 conditional area
4 output rule
5 check item
10 prediction model
11 summary model
15 storage unit
16 control unit
17 learning database
18 rule database
20 UI generation unit
21 prediction model learning unit
22 characteristic evaluation unit
23 summary model learning unit
24 explanation generation unit
25 query generation unit
26 adjustment processing unit
100 data analysis apparatus

1. An information processing apparatus, comprising:
a first learning unit that causes a predetermined learning model to perform learning;
a second learning unit that causes a conversion model to perform learning, the conversion model converting an output of the predetermined learning model into a rule group described in a format that can be interpreted by a user;
an evaluation unit that acquires evaluation information obtained by evaluating the rule group in accordance with a predetermined standard; and
an adjustment unit that adjusts learning processing of the predetermined learning model on a basis of the evaluation information.

2. The information processing apparatus according to claim 1, wherein
the predetermined standard includes at least one of a standard defined by law or a standard defined by the user.

3. The information processing apparatus according to claim 1, wherein
the learning model is a prediction model for predicting a target item.

4. The information processing apparatus according to claim 3, wherein
the rule group includes at least one output rule describing an output of the prediction model, and
the evaluation unit generates at least one of an explanatory sentence or a chart relating to each of the output rules.

5. The information processing apparatus according to claim 4, wherein
the evaluation unit generates a check item for causing the user to check whether or not each of the output rules satisfies the predetermined standard.

6. The information processing apparatus according to claim 5, wherein
the evaluation unit reads, as the evaluation information, a check result of the check item by the user.

7. The information processing apparatus according to claim 4, wherein
the evaluation unit generates the check item of a data item specified by the user among a plurality of data items included in learning data of the prediction model.

8. The information processing apparatus according to claim 4, further comprising
a storage unit that stores a database relating to the predetermined standard, wherein
the evaluation unit determines whether or not the output rule satisfies the predetermined standard on a basis of the database.

9. The information processing apparatus according to claim 8, wherein
the evaluation unit generates a check item for the output rule determined as failing to satisfy the predetermined standard, the check item causing the user to check whether or not the output rule satisfies the predetermined standard.

10. The information processing apparatus according to claim 8, wherein
the evaluation unit generates, as the evaluation information, information relating to the output rule determined as failing to satisfy the predetermined standard.

11. The information processing apparatus according to claim 4, wherein
the evaluation information includes information relating to a violation rule that is the output rule failing to satisfy the predetermined standard, and
the adjustment unit adjusts at least one of learning data of the prediction model or a learning parameter of the prediction model with reference to a data range specified by the violation rule.

12. The information processing apparatus according to claim 11, wherein
the adjustment unit performs at least one of processing to reduce the number of pieces of the learning data that causes the violation rule failing to satisfy the predetermined standard, in the learning data included in the data range specified by the violation rule, or processing to add dummy data as the learning data to the data range specified by the violation rule, the dummy data being adjusted to satisfy the predetermined standard.

13. The information processing apparatus according to claim 11, wherein
the learning parameter includes at least one of a parameter for adjusting the output of the prediction model relating to the learning data or a parameter for adjusting a loss function of the prediction model.

14. The information processing apparatus according to claim 11, wherein
the prediction model is a classification model using a classification relating to the target item as a predicted value, and
the adjustment unit adjusts learning processing of the prediction model such that the predicted value of the prediction model in the data range specified by the violation rule substantially matches the predicted value of the prediction model in a data range specified by the output rule that satisfies the predetermined standard.

15. The information processing apparatus according to claim 11, wherein
the prediction model is a regression model using a value of the target item as a predicted value, and
the adjustment unit adjusts learning processing of the prediction model such that a distribution of the predicted value of the prediction model in the data range specified by the violation rule substantially matches a distribution of the predicted value of the prediction model in a data range specified by the output rule that satisfies the predetermined standard.

16. The information processing apparatus according to claim 3, wherein
the evaluation unit presents a plurality of adjustment methods relating to an output of the prediction model in a selectable manner, and
the adjustment unit adjusts learning processing of the prediction model on a basis of a method selected by the user among the plurality of adjustment methods.

17. The information processing apparatus according to claim 1, wherein
the second learning unit causes the conversion model to perform learning, the conversion model conforming to the predetermined standard.

18. The information processing apparatus according to claim 1, wherein
the conversion model is a learning model using at least one algorithm of a decision tree or a rule fit.

19. An information processing method, comprising:
causing a predetermined learning model to perform learning;
causing a conversion model to perform learning, the conversion model converting an output of the predetermined learning model into a rule group described in a format that can be interpreted by a user;
acquiring evaluation information obtained by evaluating the rule group in accordance with a predetermined standard; and
adjusting learning processing of the predetermined learning model on a basis of the evaluation information,
which are executed by a computer system.

20. A program, which causes a computer system to execute the steps of:
causing a predetermined learning model to perform learning;
causing a conversion model to perform learning, the conversion model converting an output of the predetermined learning model into a rule group described in a format that can be interpreted by a user;
acquiring evaluation information obtained by evaluating the rule group in accordance with a predetermined standard; and
adjusting learning processing of the predetermined learning model on a basis of the evaluation information.
